(19) United States
(12) Patent Application Publication
(10) Pub. No.: US 2019/0235847 A1
(43) Pub. Date: Aug. 1, 2019

(54) ON-DEMAND EXECUTION OF CONTINUOUS DELIVERY PIPELINE SEGMENT MODELS

(71) Applicant: Integnology Corporation, SANTA CLARA, CA (US)

(72) Inventors: Tien Nguyen, MORGAN HILL, CA (US); Basheer Janjua, Half Moon Bay, CA (US); Rekha Mittal, Santa Clara, CA (US); Calvin Mak, San Ramon, CA (US); Adam R. Gensler, Millbrae, CA (US); Humphrey Alba, San Jose, CA (US)

(21) Appl. No.: 16/303,076

(22) PCT Filed: May 19, 2017
(86) PCT No.: PCT/US17/33651

§ 371 Date: Nov. 19, 2018

Related U.S. Application Data
(60) Provisional application No. 62/339,003, filed on May 19, 2016.

(51) Int. Cl. G06F 8/35; G06F 8/60

(52) U.S. Cl. CPC G06F 8/35; G06F 8/60

(57) ABSTRACT

A method comprising receiving a continuous delivery pipeline model, the continuous delivery pipeline model comprising a plurality of segment models. An on-demand start segment may be selected from the plurality of segment models based on a first user input. An on-demand end segment may be selected from the plurality of segment models based on a second user input. A portion of the continuous delivery pipeline may be identified based on the first selection and the second selection. An on-demand execution of the identified portion of the continuous delivery pipeline model may be triggered in response to a third user input.

### BACKGROUND

### Technical Field

Embodiments of the present invention relate generally to software development. More specifically, embodiments of the present inventions relate to on-demand execution of continuous delivery pipeline segment models.

### Description of Related Art

Software development is a time consuming and resource intensive process. Traditionally, software development has been broken down into several distinct stages, such as a specification or requirements stage, a design stage, a construction stage, and a production stage. Each stage can last weeks, months, or even years. Software development practices have recently begun to evolve to address such lengthy development lifecycles, however current solutions (e.g., software development platforms) have failed to provide the technical features required to rapidly create, test, and deploy software applications.

### SUMMARY

Some embodiments described herein include systems and methods for on-demand execution of continuous delivery pipeline models and continuous delivery pipeline segment models (or, “segment models”). For example, a system can control execution of one or more segment models of a continuous delivery pipeline model in response to on-demand trigger events.

In a specific implementation, a system can generate a graphical user interface (GUI) that presents a continuous delivery pipeline model including various types of segment models, e.g., continuous integration (CI) segment models, function test (FT) segment models, user acceptance test (UAT) segment models, performance test (PT) segment models, static security scan (SSS) segment models, dynamic security scan (DSS) segment models, system integration (SI) segment models, production (PROD) segment models, and the like. Particular segment models can be selected, or otherwise manipulated, through the GUI to control execution of the selected segment models, as well as other associated segment models. For example, a first segment model can be selected as a “start” segment model, and a second segment model can be selected as an “end” segment model. When an on-demand trigger event is received (e.g., in response to a user clicking on a “run” icon”), the portion of the continuous delivery pipeline model delineated by the start and end segment models can be executed. This can help, for example, reduce the amount of time required to integrate, test, build, and/or deploy applications because only selected portions of the continuous delivery pipeline model are executed. Similarly, additional on-demand trigger events can be received during an on-demand execution. For example, an on-demand execution can be paused, resumed, aborted, and/or advanced..

In some embodiments, on-demand execution of segment models trigger corresponding executions of one or more software development tools (or, “tools”) to perform continuous delivery actions (or, “actions”). For example, the tools can include a source code repository tool, a binary repository tool, an issue tracking tool, a project management tool, and a code quality tool. Similarly, actions can include CI actions (e.g., cloning a portion of the source code repository), PT actions, and so forth. In some embodiments, source code and/or artifacts can be advanced from one segment model to another segment model based on segment model dependencies and/or segment model threshold conditions defined by the segment model. For example, a particular segment model can define that an artifact is advanced to a next segment model only if all of the actions (e.g., tests) associated with a current segment model are passed.

Some embodiments described herein include systems and methods for non-disruptive continuous software delivery. For example, a system can create a continuous delivery pipeline model that can be executed in response to one or more trigger events (e.g., an on-demand trigger event, a source code commit event, etc.). Depending upon product requirements or objectives, the continuous delivery pipeline model can be created from a template model, or created from scratch. For example, the system can generate a graphical user interface (GUI) that presents various segment models, and segment models can be selected, or otherwise manipulated, through the GUI to create (or, “define”) the continuous delivery pipeline model.

In various embodiments, a method comprises receiving a continuous delivery pipeline model, the continuous delivery pipeline model comprising a plurality of segment models. An on-demand start segment may be selected from the plurality of segment models based on a first user input. An on-demand end segment may be selected from the plurality of segment models based on a second user input. A portion of the continuous delivery pipeline may be identified based on the first selection and the second selection. An on-demand execution of the identified portion of the continuous delivery pipeline model may be triggered in response to a third user input.

In some embodiments, the method further comprises determining a segment dependency based on the selection of the on-demand start segment and the on-demand end segment. In related embodiments, the segment dependency comprises any of the on-demand start segment and the on-demand end segment requiring an input from at least one of the plurality of segment models not within the identified portion of the continuous delivery pipeline model.

In some embodiments, the method further comprises reselecting any of the on-demand start segment and on-demand end segment to satisfy the segment dependency. In related embodiments, the method further comprises providing a sample input to satisfy the segment dependency.

In some embodiments, the method further comprises receiving a fourth user input during the on-demand execution of the continuous delivery pipeline model.

In some embodiments, the method further comprises terminating the execution of the continuous delivery model in response to fourth user input. In related embodiments, the method further comprises bypassing one or more segment models of the plurality of segment models during the execution of the continuous delivery model, the bypassing triggered in response to the fourth user input. In related embodiments, the one or more segment models are logically positioned between the on-demand start segment and the on-demand end segment within the continuous delivery pipeline model.

In various embodiments a system comprises an orchestrator engine configured to cooperate with the processor to (i) receive a continuous delivery pipeline model, the continuous delivery pipeline model comprising a plurality of segment models, (ii) receive a first user input, (iii) first select an on-demand start segment from the plurality of segment models, the first selection based on the first user input, (iv) receive a second user input, (v) second select an on-demand end segment from the plurality of segments, the second selection based on the second user input, (vi) identify a portion of the continuous delivery pipeline, the identification based on the first selection and the second selection, (vii) receive a third user input, and (viii) trigger an on-demand execution of the identified portion of the continuous delivery pipeline model in response to the third user input.

In some embodiments, the orchestrator engine is further configured to determine a segment dependency based on the selection of the on-demand start segment and the on-demand end segment. In related embodiments, the segment dependency comprises any of the on-demand start segment and the on-demand end segment requiring an input from at least one of the plurality of segment models not within the identified portion of the continuous delivery pipeline model. In related embodiments, the orchestrator engine is further configured to reselect any of the on-demand start segment and on-demand end segment to satisfy the segment dependency. In related embodiments, the orchestrator engine is further configured to provide a sample input to satisfy the segment dependency.

In some embodiments, the orchestrator engine is further configured to receive a fourth user input during the on-demand execution of the continuous delivery pipeline model.

In some embodiments, the orchestrator engine is further configured to terminate the execution of the continuous delivery model in response to fourth user input. In related embodiments, the orchestrator engine is further configured to bypass one or more segment models of the plurality of segment models during the execution of the continuous delivery model, the bypassing triggered in response to the fourth user input. In related embodiments, the one or more segment models are logically positioned between the on-demand start segment and the on-demand end segment within the continuous delivery pipeline model.

In various embodiments, a non-transitory computer readable medium comprises executable instructions, the instructions being executable by a processor to perform a method, the method comprising receiving a continuous delivery pipeline model, the continuous delivery pipeline model comprising a plurality of segment models. An on-demand start segment may be selected from the plurality of segment models based on a first user input. An on-demand end segment may be selected from the plurality of segment models based on a second user input. A portion of the continuous delivery pipeline may be identified based on the first selection and the second selection. An on-demand execution of the identified portion of the continuous delivery pipeline model may be triggered in response to a third user input.

### BRIEF DESCRIPTION OF THE DRAWINGS

FIG. 1 depicts a block diagram of an example system capable of providing non-disruptive continuous software delivery according to some embodiments.

FIG. 2 depicts a flowchart of an example method of operation of a system capable of providing non-disruptive continuous software delivery according to some embodiments.

FIG. 3 depicts a block diagram of an example of a non-disruptive continuous delivery system according to some embodiments.

FIG. 4 depicts a flowchart of an example method of generating and executing a custom segment model according to some embodiments.

FIG. 5 depicts a flowchart of an example method of generating a custom segment model from a template segment model according to some embodiments.

FIG. 6 depicts a flowchart of an example method of generating a custom segment model according to some embodiments.

FIG. 7 depicts a flowchart of an example method of operation of a non-disruptive continuous delivery system for generating and configuring a project and application according to some embodiments.

FIG. 8 depicts a flowchart of an example method of operation of a non-disruptive continuous delivery system for adjusting a project and application configuration according to some embodiments.

FIG. 9 depicts a flowchart of an example method of operation of a non-disruptive continuous delivery system for creating a continuous delivery pipeline model according to some embodiments.

FIG. 10 depicts a flowchart of an example method of operation of a non-disruptive continuous delivery system for executing a continuous delivery pipeline model according to some embodiments.

FIG. 11 depicts a flowchart of an example method of operation of a non-disruptive continuous delivery system for executing a pipeline segment model of a continuous delivery pipeline model according to some embodiments.

FIG. 12 depicts a flowchart of an example method of operation of a non-disruptive toolchain engine according to some embodiments.

FIG. 13 depicts a flowchart of an example method of operation of a non-disruptive toolchain engine according to some embodiments.

FIG. 14 depicts a flowchart of an example method of operation of a non-disruptive continuous delivery system according to some embodiments.

FIG. 15 depicts an example graphical user interface for generating an example continuous delivery pipeline model according to some embodiments.

FIG. 16 depicts an example continuous delivery pipeline model according to some embodiments.

FIG. 17 depicts a flowchart of an example method of on-demand execution according to some embodiments.

FIG. 18 depicts a block diagram of an example computing device according to some embodiments.

### DETAILED DESCRIPTION

Some embodiments described herein include systems and methods for on-demand execution of continuous delivery pipeline models and continuous delivery pipeline segment models (or, “segment models”). For example, a system can control execution of one or more segment models of a continuous delivery pipeline model in response to on-demand trigger events.

In a specific implementation, a system can generate a graphical user interface (GUI) that presents a continuous delivery pipeline model including various types of segment models, e.g., continuous integration (CI) segment models, function test (FT) segment models, user acceptance test (UAT) segment models, performance test (PT) segment models, static security scan (SSS) segment models, dynamic security scan (DSS) segment models, system integration (SI) segment models, production (PROD) segment models, and the like. Particular segment models can be selected, or otherwise manipulated, through the GUI to control execution of the selected segment models, as well as other associated segment models. For example, a first segment model can be selected as a “start” segment model, and a second segment model can be selected as an “end” segment model. When an on-demand trigger event is received (e.g., in response to a user clicking on a “run” icon”), the portion of the continuous delivery pipeline model delineated by the start and end segment models can be executed. This can help, for example, reduce the amount of time required to integrate, test, build, and/or deploy applications because only selected portions of the continuous delivery pipeline model are executed. Similarly, additional on-demand trigger events can be received during an on-demand execution. For example, an on-demand execution can be paused, resumed, aborted, and/or advanced.

In some embodiments, on-demand execution of segment models trigger corresponding executions of one or more software development tools (or, “tools”) to perform continuous delivery actions (or, “actions”). For example, the tools can include a source code repository tool, a binary repository tool, an issue tracking tool, a project management tool, and a code quality tool. Similarly, actions can include CI actions (e.g., cloning a portion of the source code repository), PT actions, and so forth. In some embodiments, source code and/or artifacts can be advanced from one segment model to another segment model based on segment model dependencies and/or segment model threshold conditions defined by the segment model. For example, a particular segment model can define that an artifact is advanced to a next segment model only if all of the actions (e.g., tests) associated with a current segment model are passed.

Some embodiments described herein include systems and methods for non-disruptive continuous software delivery. For example, a system can create a continuous delivery pipeline model that can be executed in response to one or more trigger events (e.g., an on-demand trigger event, a source code commit event, etc.). Depending upon product requirements or objectives, the continuous delivery pipeline model can be created from a template model, or created from scratch. For example, the system can generate a graphical user interface (GUI) that presents various segment models, and segment models can be selected, or otherwise manipulated, through the GUI to create (or, “define”) the continuous delivery pipeline model.

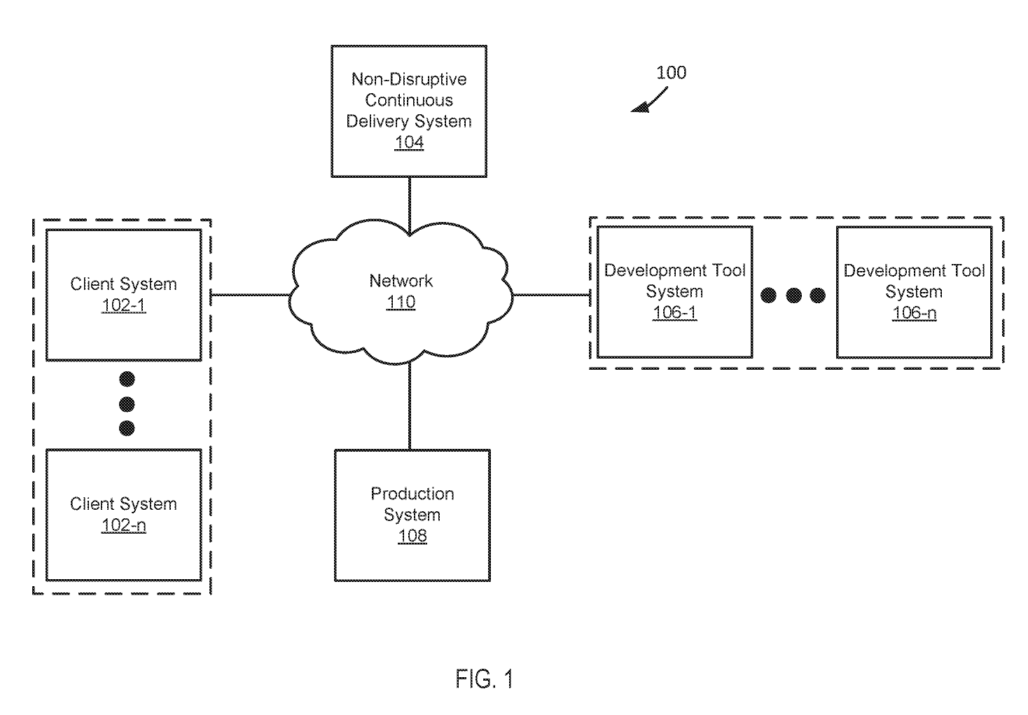

FIG. 1 depicts a block diagram 100 of an example system capable of providing non-disruptive continuous software delivery according to some embodiments. The example system of FIG. 1 includes client systems 102-1 to 102-n (individually, the client system 102, collectively, the client systems 102), a non-disruptive continuous delivery system 104, development tools 106-1 to 106-n (individually, the development tool 106, collectively, the development tools 106), a production system 108, and a communications network 110.

In the example of FIG. 1, the client systems 102 function to generate source code for software development projects (e.g., an online music store) and applications (e.g., a genre selection feature of the online music store). For example, the functionality of the client systems 102 can be performed by one or more workstations, desktop computers, laptop computers, mobile devices (e.g., smartphone, cell phone, smartwatch, tablet computer, etc.), and the like. In a specific implementation, the client systems 102 function to execute local and/or networked-based applications (e.g., web browsers, remote communication clients, software development platforms and environments, etc.).

In a specific implementation, the client systems 102 function to access or otherwise communicate with one or more of the other systems of FIG. 1. For example, the client systems 102 can receive data from other systems (e.g., to render user interfaces based on received data), display graphics rendered by other systems, transmit data to other systems, and so forth. In various implementations, the user interfaces may be configured to receive user input, e.g., for software development. It will be appreciated that while many client systems 102 may be different, they may also share some common features. For example, the client systems 102 can include some method of capturing user input such as via a keyboard, mouse, touchscreen, touchpad, or the like. The client systems 102 may also have some method of displaying a two-dimensional or three-dimensional images using a display, such as an LED, an LCD, or a touchscreen.

In the example of FIG. 1, the non-disruptive continuous delivery system 104 functions to continuously integrate, build, test, and deploy software in accordance with the teachings herein. For example, the functionality of the non-disruptive continuous delivery system 104 can be performed by one or more computing devices, such as workstations, desktop computers, laptop computers, mobile devices (e.g., smartphone, cell phone, smartwatch, tablet computer, etc.), and the like. In a specific implementation, some or all of the features of the non-disruptive continuous delivery system 104 can be performed by the computing device(s) performing the functionality of a client system 102.

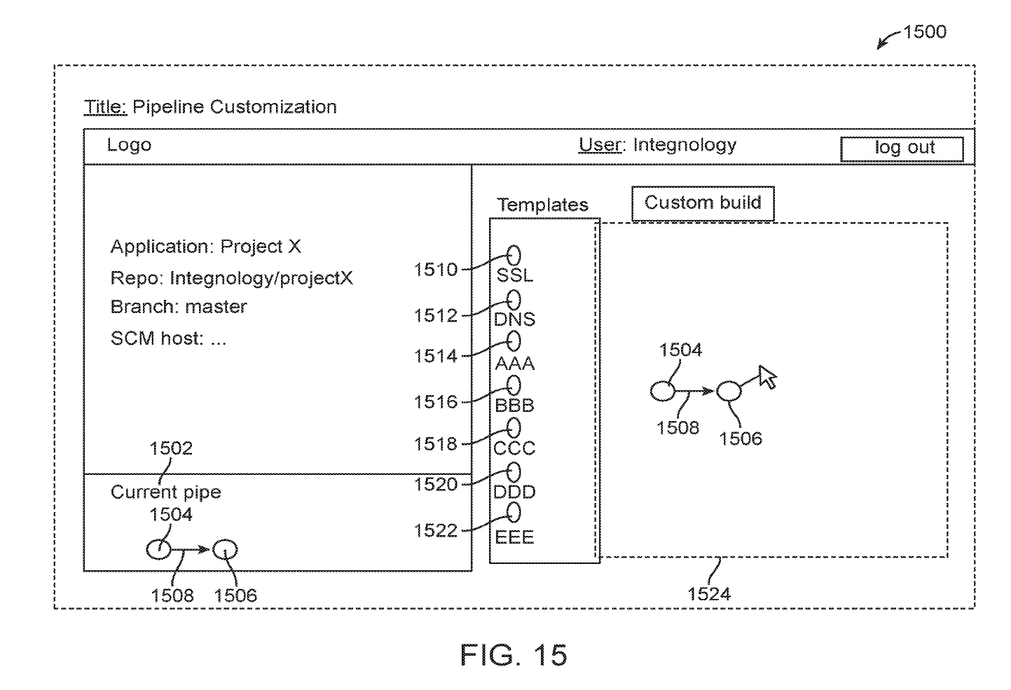

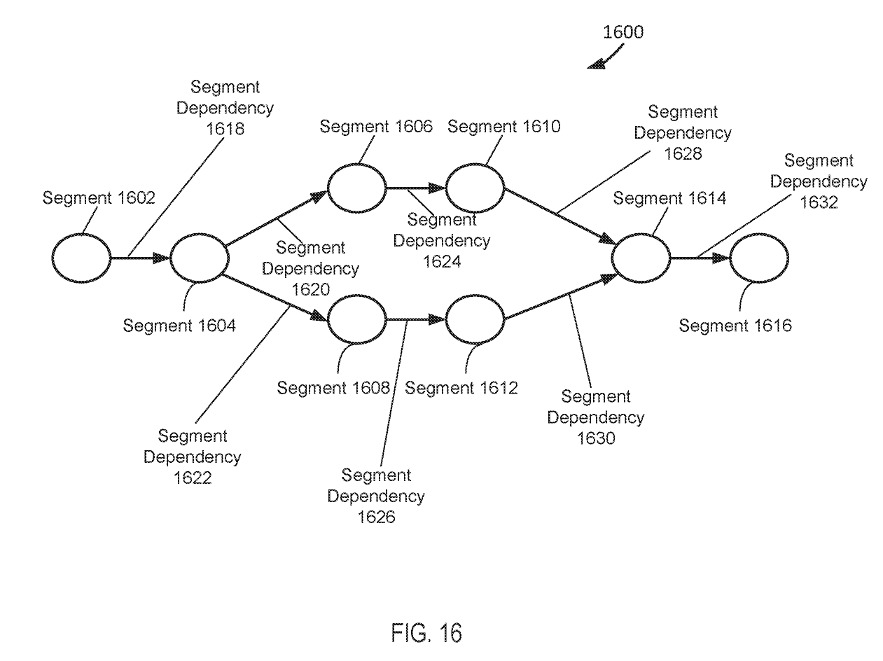

In the example of FIG. 1, the non-disruptive continuous delivery system 104 functions to create continuous delivery software development projects (or, “projects”), continuous delivery software development applications (or, “applications”), and continuous delivery pipeline models. For example, a project may comprise an online music store platform, and an application may comprise a genre selection feature of the online music store platform. In a specific implementation, and as discussed elsewhere herein, a continuous delivery pipeline model is comprised of a plurality of pipeline segment models. For example, the pipeline segment models can define various operations that must be passed in order for artifacts and/or binaries to advance to subsequent pipeline segment models, and eventually be deployed to a production system. In a specific implementation, the non-disruptive continuous delivery system 104 additionally functions to provide a graphical user interface for creating projects, application, and continuous delivery pipeline models. An example interface for creating a continuous delivery pipeline model is shown in FIG. 15, and an example continuous delivery pipeline model is shown in FIG. 16.

In the example of FIG. 1, the development tools 106 function to perform a variety of software development actions. For example, the functionality of the development tools 106 can be performed by one or more workstations, desktop computers, laptop computers, mobile devices (e.g., smartphone, cell phone, smartwatch, tablet computer, etc.), and the like. In a specific implementation, the functionality of the development tools 106 can be performed by some or all of the computing devices performing the functionality of the non-continuous delivery system 104. In a specific implementation, the development tools 106 include one or more source code management (SCM) tools, binary repository tools, issue tracking tools, project management tools, and code quality tools, just to name a few.

In the example of FIG. 1, the production system 110 functions to provide a live production environment for the projects and applications to be deployed. For example, the functionality of the production system 110 can be performed by one or more computing devices, such as workstations, desktop computers, laptop computers, mobile devices (e.g., smartphone, cell phone, smartwatch, tablet computer, etc.), and the like. In a specific implementation, the production system 110 comprises a live production environment hosted by a cloud storage service (e.g., AWS, CloudFoundry, Azure, Openstack) and/or other type of storage (e.g., Heritage).

In the example of FIG. 1, the communications network 110 represents one or more computer networks (e.g., LAN, WAN, etc.). The communications network 100 may provide communication between the client systems 102, the non-disruptive continuous delivery system 104, the development tools 106, and the production system 108. In some implementations, the communications network 110 comprises computing devices, routers, cables, buses, and/or other network topologies. In some implementations, the communications network 110 may be wired and/or wireless. In various implementations, the communications network 110 may comprise the Internet, one or more networks that may be public, private, IP-based, non-IP based, and so forth. In a specific implementation, the communications network 110 comprises a cloud-based communications network.

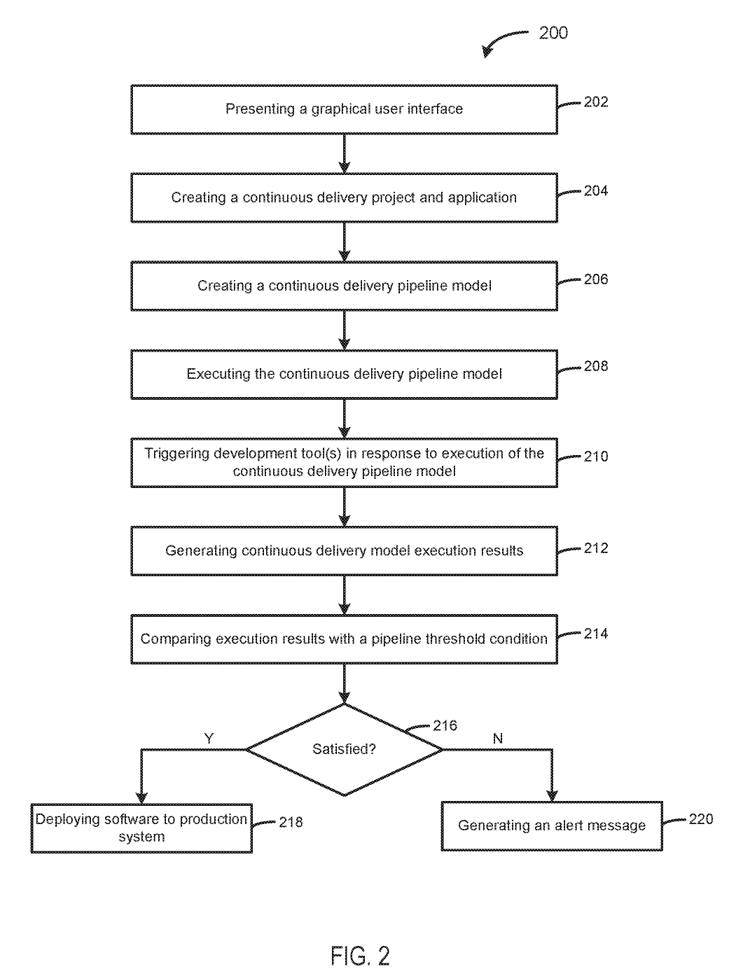

FIG. 2 depicts a flowchart 200 of an example method of operation of a system capable of providing non-disruptive continuous software delivery according to some embodiments. In this and other flowcharts described in this paper, the flowchart illustrates by way of example a sequence of steps. It should be understood the steps can be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 202, a client computer system presents a graphical user interface (GUI) for creating a project, an application, and a continuous delivery pipeline model. In a specific implementation, the GUI elements are generated remote from the computer system (e.g., a the non-disruptive continuous delivery system) and rendered locally (e.g., by a web browser or other client presentation application). In other implementations, some or all of the GUI elements are generated and rendered locally. An example GUI for creating a continuous delivery pipeline is shown in FIG. 15.

In step 204, the non-disruptive continuous delivery system creates the project and application. In a specific implementation, the project and application are created in response to, and based on, user input received through the GUI. For example, the user can include a project name, an application name, selected development tools to include the project and application configurations, and so forth.

In step 206, the non-disruptive continuous delivery system creates a continuous delivery pipeline model associated with the application. In a specific implementation, the continuous delivery pipeline model can be created in response to, and based on, user input received through the GUI. For example, the user input can include pipeline segment model selections. An example continuous delivery model is shown in FIG. 16.

In step 208, the non-disruptive continuous delivery system executes the continuous delivery pipeline model for the associated application, or portion thereof. In a specific implementation, the continuous delivery pipeline model can be executed in response to a trigger event (e.g., a source code commit event). In a specific implementation, the continuous delivery pipeline model can receive source code associated with the trigger event as an input.

In step 210, the non-disruptive continuous delivery system triggers one or more development tools to perform one or more continuous delivery actions in response to execution of the continuous delivery pipeline model.

In step 212, the non-disruptive continuous delivery system generates continuous delivery model execution results, and compares the results with a threshold condition (step 214). For example, the execution results can include a percentage of tests, functions, and/or other operations defined by the continuous delivery model that were successfully passed (e.g., 80%), and the threshold condition may define a minimum pass rate (e.g., 100%) required to successfully complete the continuous delivery pipeline model.

In step 216, the non-disruptive continuous delivery system determines if execution of the continuous delivery pipeline model succeeds or fails based on the comparison. For example, if the execution results satisfy the threshold condition, then the application, or portion thereof, associated with the continuous delivery pipeline model can be deployed to a production system (step 218). If the execution results fail to satisfy the threshold condition, the software may not be deployed to the production system, and an alert may be generated (step 220).

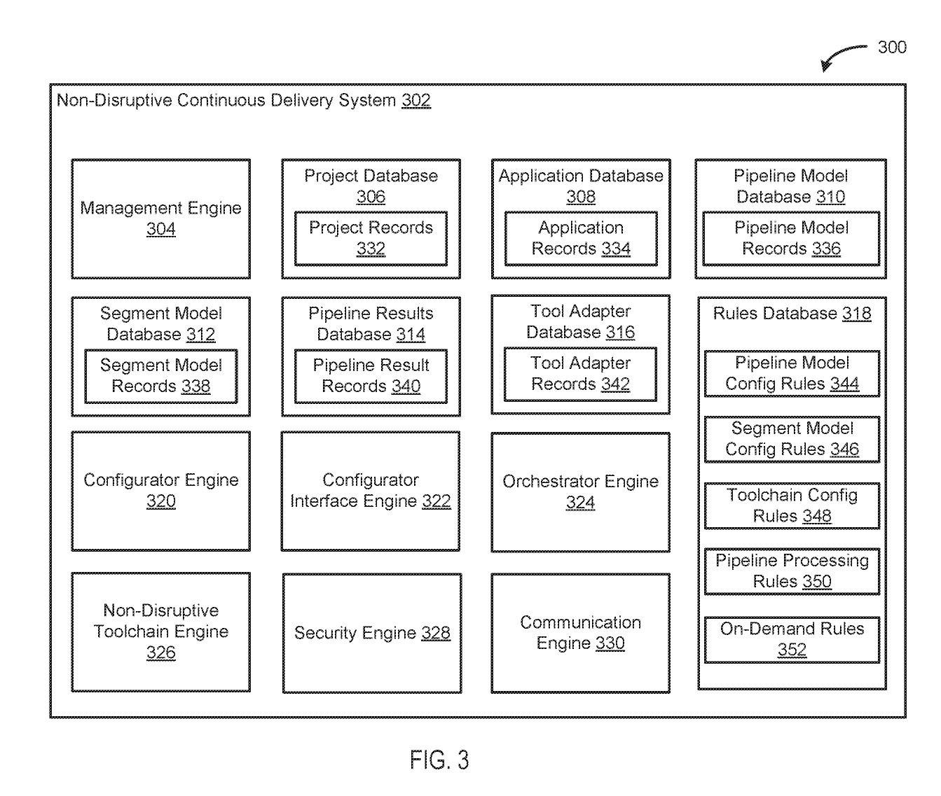

FIG. 3 depicts a block diagram 300 of an example of a non-disruptive continuous delivery system 302 according to some embodiments. Generally, the non-disruptive continuous delivery system 302 functions to continuously integrate, build, test, and deploy projects and/or applications. The continuous delivery system 302 includes a management engine 304, a project database 306, an application database 308, a pipeline model database 310, a pipeline segment model database 312, a pipeline results database 314, a tool adapter database 316, a rules database 318, a configurator engine 320, a configurator interface engine 322, an orchestrator engine 324, a non-disruptive toolchain engine 326, a security engine 328, and a communication engine 330.

In the example of FIG. 3, the management engine 304 is configured to manage (e.g., create, read, update, delete, or otherwise access) project records 332 stored in the project database 306, application records 334 stored in the application database 308, pipeline model records 336 stored in the pipeline model database 310, pipeline segment model records 338 stored in the pipeline segment model database 312, pipeline result records 340 stored in the pipeline results database 314, tool adapter records 342 stored in the tool adapter database 316, and rules 344-352 stored in the rules database 318. The management engine 304 may perform any of these operations manually (e.g., by an administrator interacting with a GUI) and/or automatically (e.g., by one or more of the engines 320-330). In a specific implementation, the management engine 304 comprises a library of executable instructions which are executable by a processor for performing any of the aforementioned management operations. The databases 306-318 may be any structure and/or structures suitable for storing the records 332-342 and/or the rules 344-352 (e.g., an active database, a relational database, a table, a matrix, an array, a flat file, and the like).

In the example of FIG. 3, the project records 332 may each include a variety of attributes and values associated with a project. For example, a project may comprise an online music store platform being developed in accordance with the teachings herein. In a specific implementation, the project records 332 store some or all of the following data:
Project Identifier: an identifier (e.g., a key or UID) that identifies the stored project.
Project Name: name of the stored project (e.g., online music store platform).
Application(s): one or more applications associated with the stored project. For example, an application may include a particular feature (e.g., selecting a music genre) of the stored project.
Rule(s): one or more rules (e.g., rules 344-352) associated with the stored project.
Tool(s): one or more tools (e.g., Stash, Bitbucket, etc.) associated with the project.
Permissions: permissions required to access the stored project. For example, permissions may be based on a user role (e.g., “developer,” “administrator,” etc.), a user-by-user basis, and so forth.
Timestamp(s): time/date information for associated CRUD operations performed on the stored project record, e.g., Project Online Music Store created on 2016-05-01@1:30PM.

In the example of FIG. 3, the application records 334 may each include a variety of attributes and values associated with an application of a project. For example, an application may comprise a genre selection feature of an online music store platform project being developed in accordance with the teachings herein. In a specific implementation, the application records 334 store some or all of the following data:
Application Identifier: an identifier (e.g., a key or UID) that identifies the stored application.
Application Name: name of the stored application (e.g., music genre selection).
Project: project associated with the stored application.
Tool(s): one or more tools (e.g., Stash, Bitbucket, etc.) associated with the application.
Continuous Delivery Pipeline Model(s): one or more continuous delivery pipeline model(s) associated with the stored application.
Rule(s): one or more rules (e.g., rules 344-352) associated with the stored application.
Permissions: permissions required to access the stored application. For example, permissions may be based on a user role (e.g., “developer,” “administrator,” etc.), a user-by-user basis, and so forth.
Timestamp(s): time/date information for associated CRUD operations performed on the stored application record, e.g., “Application Music Genre Selection Application created on 2016-05-01@1:35PM.”

In the example of FIG. 3, the pipeline model records 336 may each include a variety of attributes and values associated with a continuous delivery pipeline model. For example, a continuous delivery pipeline model may comprise a model (e.g., data model and/or function model) for continuously integrating, building, testing, and deploying an application or project. In a specific implementation, the continuous delivery pipeline model comprises a node graph (e.g., directed node graph) model. In various implementations, the pipeline model records 336 store some or all of the following data:
Pipeline Model Identifier: an identifier (e.g., a key or UID) that identifies the stored continuous delivery pipeline model.
Template or Custom: indicates whether the continuous delivery pipeline model is a template model or a custom build model.
Pipeline Model Name: name of the stored continuous delivery pipeline model.
Application(s): one or more applications associated with the stored continuous delivery pipeline model.
Project(s): one or more projects associated with the stored continuous delivery pipeline model.
Pipeline Segment Model(s): one or more pipeline segment model(s) included in the stored continuous delivery pipeline model.
Segment Model Dependencies: pipeline segment model dependencies included in the stored continuous delivery pipeline model. For example, a second pipeline segment model (e.g., an FT pipeline segment model) can depend on an execution result (e.g., a pass value) of a first pipeline segment model (e.g., a CI pipeline segment model).
Rule(s): one or more rules (e.g., rules 344-352) associated with the stored continuous delivery pipeline model.
Permissions: permissions required to access the stored continuous delivery pipeline model. For example, permissions can be based on a user role (e.g., “developer,” “administrator,” etc.), a user-by-user basis, and so forth.
Timestamp(s): Time/date information for associated CRUD operations performed on the stored continuous delivery pipeline model. For example, timestamp information can be generated when a CRUD operation is performed, e.g., creating the continuous delivery pipeline model, executing the continuous delivery pipeline model, etc.

In the example of FIG. 3, the pipeline segment model records 338 may each include a variety of attributes and values associated with a continuous delivery model pipeline segment model (or, “pipeline segment model”). For example, a pipeline segment model can comprise a CI segment model, a FT segment model, a UAT segment model, a PT segment model, a SSS segment model, a DSS segment model, an SI segment model, a PROD segment model, and the like. In various implementations, pipeline segments can be executed in different environments (e.g., an AWS environment or other cloud computing environment), For example, a CI pipeline segment of a continuous delivery pipeline model may be executed in a first environment, and an FT pipeline segment of the same continuous delivery pipeline model may be executed in a different environment. In a specific implementation, the pipeline segment model records 338 store some or all of the following data:
Segment Model Identifier: an identifier (e.g., a key or UID) that identifies the stored segment model.
Segment Model Type: the type of segment model stored in the segment model record, e.g., CI segment model, a FT segment model, a UAT segment model, a PT segment model, a SSS segment model, a DSS segment model, an SI segment model, a PROD, etc.
Template or Custom: indicates whether the segment model is a template segment model or a custom build segment model (or, “custom segment model”).
Event(s): event(s) associated with the stored segment model, e.g., a “Start Event” that may be triggered when a pipeline segment model is triggered during execution of a continuous delivery pipeline model, an “End Event” that may triggered upon completed “Start Event” of a pipeline segment model execution, and so forth.
Task(s): tasks (or, “actions”) associated with the stored pipeline segment model and/or event (e.g., Start Event). Tasks may be triggered during an execution of a continuous delivery pipeline model including the stored pipeline segment model. For example, an action associated with a CI pipeline segment model type can include cloning a source code repository. When a task is triggered, it may cause associated tool(s) to perform the task(s).
Segment Model Dependencies: identifies dependencies of the stored segment model type. For example, an FT segment model may require input from a CI segment model, or particular segment model may defined dependency between tasks. Accordingly, an alert may be generated if a user attempts to create a continuous delivery pipeline model or a segment model that violates one or more dependencies. In a specific implementation, segment model dependencies can include requirements and/or predetermined data for on-demand execution (e.g., input values, output values, source code, artifacts, binaries, etc.).
Segment Priorities: a priority (e.g., critical, non-critical, high, low, etc.) of the segment model, events of the segment model, and/or tasks of the segment model.
Task Sequence: an execution sequence of the task(s). In a specific implementation, the task sequence can be based on one or more segment priorities. For example, a particular task sequence may define that only tasks with a particular priority should be executed (e.g., critical).
Rule(s): rules associated with the stored pipeline segment model, e.g., rules 344-352.

In the example of FIG. 3, the pipeline result records 340 may each include a variety of attributes and values associated with results of continuous delivery pipeline model executions (or, “runs”). In a specific implementation, the pipeline result records 340 store some or all of the following data:
Result Identifier: an identifier (e.g., a key or UID) that identifies the stored result record.
Continuous Delivery Pipeline Model: the continuous delivery pipeline model that generated the result record.
Segment Model: the segment model that generated the result record.
Project: the project associated with the continuous delivery pipeline model.
Application: the application associated with the continuous delivery pipeline model.
Overall Pipeline Result: an overall result of execution of the continuous delivery pipeline model. For example, an overall pipeline result can be a qualitative value (e.g., “Pass” or “Fail”), and/or a quantitative value (e.g., percentage value).
Overall Segment Model Results: overall result of execution for each of the segment models of the continuous delivery pipeline model. For example, an overall segment model result can be a qualitative value (e.g., “Pass,” “Fail,” or “Not Executed”), and/or a quantitative value (e.g., percentage a tasks passed).
Event Results: a result of execution for each of the events of the segment models. For example, an event result can be a qualitative value (e.g., “Pass,” “Fail,” or “Not Executed”), and/or a quantitative value (e.g., percentage tasks passed).
Task Results: a result of execution for each of the tasks of the segment models. For example, a task result can be a qualitative value (e.g., “Pass,” “Fail,” or “Not Executed”), and/or a quantitative value (e.g., percentage value).
Timestamps: time/date information for the stored results. For example, timestamp information can indicate when a continuous delivery pipeline model execution started, when a continuous delivery pipeline model execution ended, as well as timestamp data for event results, segment model results, and task results.

In the example of FIG. 3, the tool adapter records 342 may each include a variety of attributes and values associated with a tool adapter. In a specific implementation, a tool adapter allows the system 302 to execute, and otherwise communicate with, different types of tools, regardless of the tool implementation. In a specific implementation, the tool adapter records 342 store some or all of the following data:
Tool Adapter Identifier: an identifier (e.g., a key or UID) that identifies the stored tool adapter.
Tool Type: the type of tool. For example, tool types can include a source code repository tool, a binary repository tool, an issue tracking tool, a project management tool, and/or a code quality tool.
Tool Implementation: the particular tool implementation (e.g., Stash).
Rule(s): one or more rules (e.g., rules 344-352) associated with the stored tool adapter.

Continuous Delivery Pipeline Model Configuration Rules 344

In the example of FIG. 3, the continuous delivery pipeline model configuration rules 344 (or, “pipeline model configuration rules”) define attributes, functions, and/or conditions for configuring and generating continuous delivery pipeline models. In a specific implementation, the rules 344 specify, identify, and/or define a model (e.g., node graph model) to use for continuously integrating, building, testing, and deploying projects and applications. The rules 344 may further define input values, output values, and dependencies for the continuous delivery pipeline model.

In a specific implementation, the rules 344 define conditions for selecting a particular pipeline segment model when creating a continuous delivery pipeline model. For example, the rules 344 may require a particular start segment model (e.g., CI segment model) and/or a particular end segment model (e.g., PROD) when creating a particular continuous delivery pipeline model. Similarly, the rules 344 may include segment model dependencies. In a specific implementation, the rules 344 may dynamically determine which pipeline segment models are available for selection at a given point during the pipeline configuration. For example, for an “empty” pipeline, the rules 344 may only allow the CI segment model to be selected, but after the CI segment model is selected, one or more other segment models may become available for inclusion in the continuous delivery pipeline model.

In a specific implementation, the rules 344 permit manual definition of some or all segment model dependencies within a continuous delivery pipeline model in response to user input. For example, a user may select an FT segment model, a PT segment model, and define that the PT segment model depends on the FT segment model for a particular continuous delivery pipeline model.

In a specific implementation, the rules 344 permit automatic definition of some or all segment model dependencies within a continuous delivery pipeline model without requiring dependency-specific input from a user. For example, the rules 344 may define a set of dependencies for each segment model such that the system 302 may infer a particular dependency for a particular combination of segment models. For example, if a pipeline includes a CI segment model and an FT segment model and a PROD segment model, the rules may allow the system 302 to infer that the FT segment model depends on the CI segment model, and the PROD segment model depends on the CI segment model without requiring input from a user specifying such dependencies.

In a specific implementation, the rules 344 define one or more sets of template continuous delivery pipeline models (or, “template models”). For example, template models can be associated with one or more objectives or requirements, e.g., (no-fault tolerance system, cloud-based system, etc.), and the rules 344 may instruct the system 302 to present particular set(s), or subset(s), of template models in response to a user input.

Continuous Delivery Pipeline Segment Model Configuration Rules 346

In the example of FIG. 3, the continuous delivery pipeline segment model configuration rules 346 (or, “segment model configuration rules”) define attributes, functions, and/or conditions for configuring and generating segment models. For example, segment models can be created from template segment models and/or from scratch. In a specific implementation, segment model attributes (e.g., segment model actions, segment model action sequences, segment model threshold conditions, segment model dependencies, etc.) can be modified, adjusted, and/or reordered. Similarly, in a specific implementation, new model attributes can be created. In a specific implementation, the rules 346 specify, identify, and/or define a model (e.g., node graph model) for continuously integrating, building, testing, and/or deploying applications. In various implementations, the rules 346 define input values, output values, and dependencies for the segment models.

Toolchain Configuration Rules 348

In the example of FIG. 3, the toolchain configuration rules 348 define attributes, functions, and/or conditions for configuring a set of tools to generate a toolchain. In a specific implementation, the rules 348 allow the system 302 to automatically configure tools without requiring input from a user. For example, the rules 344 can include predefined configuration data for each available tool (e.g., Stash, Bitbucket, Jenkins, etc.).

In the example of FIG. 3, the configurator engine 320 may be configured to execute the pipeline model configuration rules 344, the pipeline segment model configuration rules 346, and the toolchain configuration rules 348. Thus, for example, the configurator engine 320 may generate and configure various projects (e.g., the projects stored in the project records 332), applications (e.g., the applications stored in the application records 334), continuous delivery pipeline models (e.g., the models stored in the records 336), and pipeline segment models (e.g., stored in the segment model database 338.

In the example of FIG. 3, the configurator interface engine 322 is configured to generate graphical user interfaces for interacting with the configurator engine 320 and other features of the system 302 (e.g., databases 306-316). For example, the configurator interface engine 322 can generate interfaces for creating and/or adjusting template segment models, new segment models, projects, applications, and continuous delivery pipeline models. Similarly, in some implementations, the configurator interface engine 322 can generate displays for presenting pipeline execution results and/or segment model execution results. An example interface that may be generated by the configurator interface engine 322 is shown in FIG. 15.

Continuous Delivery Pipeline Model Processing Rules 350

In the example of FIG. 3, the continuous delivery pipeline model processing rules 350 define attributes, functions, and/or conditions for executing continuous delivery pipeline models. In a specific implementation, the rules 350 define trigger events. Trigger events can cause an execution of a continuous delivery pipeline model. For example, a trigger event can include a source code commit event.

In a specific implementation, the rules 350 define overall pipeline threshold conditions for determining whether to deploy a project or application to a production system. For example, an overall threshold pipeline condition can be a qualitative condition (e.g., “pass,” or “fail”) and/or a quantitative condition, such as greater or less than a predetermined value (e.g., 100%). Accordingly, an overall threshold condition may be satisfied if 100% of the pipeline segment models within a particular continuous pipeline model execution are passed.

In a specific implementation, the rules 350 define pipeline segment model threshold conditions for determining whether a continuous delivery pipeline model execution is advanced to a next pipeline segment model or terminated. For example, a pipeline segment model threshold condition can be a qualitative condition (e.g., “pass,” or “fail”) and/or a quantitative condition, such as greater or less than a predetermined value (e.g., 100%). Accordingly, a pipeline segment model threshold condition may be satisfied if 100% of the events and/or tasks within a particular pipeline segment model execution are passed.

In a specific implementation, the rules 350 define pipeline segment model gate conditions for determining whether a continuous delivery pipeline model execution is advanced to a next pipeline segment model, terminated, or held. The gate condition can be in addition to, or instead of, other conditions (e.g., pipeline segment model threshold conditions). For example, a gate condition may require an administrator, or other user with sufficient privileges, to approve a pipeline advancement prior to actually advancing an execution of the continuous delivery pipeline model. For example, a PROD segment model may require an administrator to approve application deployment prior to deploying the application to a production system.

In a specific implementation, a pipeline segment can include one or more quality gate conditions, and/or quality gate conditions can include different condition types. For example, a pipeline segment can include one or more quality gate conditions, and the condition types can include critical conditions, non-critical conditions, and/or the like. Each condition type can be associated with a threshold value and/or value range (collectively, “value”). For example, critical condition types may be associated with a 100% pass rate in order for the continuous delivery pipeline model to advance to the next pipeline segment, while a non-critical condition type may be associated with a 90% pass rate in order for the continuous delivery pipeline model to advance to the next pipeline segment.

In a specific implementation, the rules 350 define events associated with pipeline segment models. For example, events may include some or all of the following:
Event ID: an identifier (e.g., a key or UID) that identifies the event.
Pipeline Segment Model: an associated segment model and/or segment model type.
Project: an associated project.
Application: an associated application.
Status: a status of the event execution, e.g., completed, not started, in progress.
Result: a result of the event execution, e.g., pass, fail, 90% passed, 10% failed, etc.
Event Threshold Condition: a condition that must be satisfied for the event to pass.
Timestamp: date/time information the event was executed.

In a specific implementation, event attribute values may be stored in one or more databases (e.g., pipeline model database 310, pipeline segment model database 312, and/or pipeline results database 314).

In a specific implementation, the rules 350 define tasks associated with pipeline segment models. For example, tasks may include some or all of the following:
Task ID: an identifier (e.g., a key or UID) that identifies the task.
Action(s): one or more actions.
Tool Type: the type of tool to perform the action.
Status: a status of the task, e.g., completed, not started, in progress, etc.
Result: a result of the task, e.g., pass, fail, etc.
Task Threshold Condition: a condition that must be satisfied for the task to pass.
Timestamp: date/time information task was executed.

In a specific implementation, task attribute values may be stored in one or more databases (e.g., pipeline model database 310, pipeline segment model database 312, and/or pipeline results database 314).

Continuous Delivery Pipeline Model On-Demand Processing Rules 352

In the example of FIG. 3, the continuous delivery pipeline model on-demand processing rules 352 (or, “on-demand processing rules”) define attributes, functions, and/or conditions for controlling execution of continuous delivery pipeline models, or portions thereof, on-demand, e.g., in response to user input as opposed to a source code commit event.

In a specific implementation, controlling execution can include (i) initiating an execution of a continuous delivery pipeline model, or portion thereof, (ii) aborting an execution of a continuous delivery pipeline model, or portion thereof, (iii) pausing an execution of a continuous delivery pipeline model, or portion thereof, (iv) skipping an execution of a continuous delivery pipeline model, or portion thereof, and/or (v) bypassing an execution of a continuous delivery pipeline model, or portion thereof. For example, while a continuous delivery pipeline model is executing, a user (e.g., via clicking a button on GUI or issuing another command) can pause an execution, resume a paused execution, abort an execution, skip a portion of the execution (e.g., a currently executing model segment or subsequent model segments), and/or bypass a portion of the execution (e.g., a currently executing model segment or subsequent model segments). In a specific implementation, bypassing comprises a skip operation and further provides predetermined data, such as a predetermined execution result (e.g., a pass result) and/or other value (e.g., sample code), for the bypassed portion, e.g., as if the bypassed portion actually generated the predetermined data during an actual execution.

In a specific implementation, the rules 352 define on-demand trigger events. On-demand trigger events can initiate a control of a continuous delivery pipeline execution. On-demand trigger events can be generated in response to a user interacting with a GUI (e.g., clicking a “start” icon, “stop” icon, etc.) or issue other commands.

In a specific implementation, the rules 352 define overall pipeline threshold conditions for determining whether to deploy a project or application to a production system for an on-demand execution. For example, an overall threshold pipeline condition can be a qualitative condition (e.g., “pass,” or “fail”) and/or a quantitative condition, such as greater or less than a predetermined value (e.g., 100%). Accordingly, an overall threshold condition may be satisfied if 100% of the pipeline segment models within a particular continuous pipeline model on-demand execution are passed.

In a specific implementation, the rules 352 define pipeline segment model threshold conditions for determining whether a continuous delivery pipeline model on-demand execution is advanced to a next pipeline segment model or terminated. For example, a pipeline segment model threshold condition can be a qualitative condition (e.g., “pass,” or “fail”) and/or a quantitative condition, such as greater or less than a predetermined value (e.g., 100%). Accordingly, a pipeline segment model threshold condition may be satisfied if 100% if the events and/or tasks within a particular pipeline segment model on-demand execution are passed.

In a specific implementation, the rules 352 define pipeline segment model gate conditions for determining whether a continuous delivery pipeline model on-demand execution is advanced to a next pipeline segment model, terminated, or held. The gate condition can be in addition to, or instead of, other conditions (e.g., pipeline segment model threshold conditions). For example, a gate condition may require an administrator, or other user with sufficient privileges, to approve a pipeline advancement prior to actually advancing an execution of the continuous delivery pipeline model. For example, a PROD segment model may require an administrator to approve application deployment prior to deploying the application to a production system.

In a specific implementation, a pipeline segment can include one or more quality gate conditions, and/or quality gate conditions can include different condition types. The quality gates conditions may be used to determine whether an application is promoted to a next stage or next segment. For example, a pipeline segment can include one or more quality gate conditions, and the condition types can include critical conditions, non-critical conditions, and/or the like. Each condition type can be associated with a threshold value and/or value range (collectively, “value”). For example, critical condition types may be associated with a 100% pass rate in order for the continuous delivery pipeline model to advance to the next pipeline segment, while a non-critical condition type may be associated with a 90% pass rate in order for the continuous delivery pipeline model to advance to the next pipeline segment.

In a specific implementation, the rules 352 define events associated with pipeline segment models. For example, events may include some or all of the following:
Event ID: an identifier (e.g., a key or UID) that identifies the event.
Pipeline Segment Model: an associated segment model and/or segment model type.
Project: an associated project.
Application: an associated application.
Status: a status of the event execution, e.g., completed, not started, in progress.
Result: a result of the event execution, e.g., pass, fail, 90% passed, 10% failed, etc.
Event Threshold Condition: a condition that must be satisfied for the event to pass.
Timestamp: date/time information the event was executed.

In a specific implementation, event attribute values may be stored in one or more databases (e.g., pipeline model database 310, pipeline segment model database 312, and/or pipeline results database 314).

In a specific implementation, the rules 352 define tasks associated with pipeline segment models. For example, tasks may include some or all of the following:
Task ID: an identifier (e.g., a key or UID) that identifies the task.
Action(s): one or more actions.
Tool Type: the type of tool to perform the action.
Status: a status of the task, e.g., completed, not started, in progress, etc.
Result: a result of the task, e.g., pass, fail, etc.
Task Threshold Condition: a condition that must be satisfied for the task to pass.
Timestamp: date/time information task was executed.

In a specific implementation, task attribute values may be stored in one or more databases (e.g., pipeline model database 310, pipeline segment model database 312, and/or pipeline results database 314).

In the example of FIG. 3, the orchestrator engine 324 is configured to execute the continuous delivery pipeline model processing rules 350 and the on-demand processing rules 352. Thus, for example, the orchestrator engine 324 can determine trigger events, trigger execution of continuous delivery pipeline models, trigger on-demand control of portions of continuous delivery pipeline models, determine an execute events, tasks, and/or actions (collectively, “actions”), identify tool types to perform the actions, determine execution results, determine whether to advance, terminate, or hold an execution of a continuous delivery model, and the like.

In the example of FIG. 3, the non-disruptive toolchain engine 326 is configured to trigger execution of one or more tools. In a specific implementation, the engine 326 utilizes tool adapters to trigger execution of the one or more tools regarding of tool implementations. For example, each tool can be associated with a tool adapter, and the engine 326 can trigger actions of a particular tool using a corresponding tool adapter. Accordingly, when a continuous delivery pipeline model is executed, the engine 326 can interface with other components of the system 302 to trigger actions of the appropriate corresponding tools without the other components requiring tool implementation-specific information. This can also permit, for example, changing of tools without substantially interrupting operation of the system 302, since the other components do not require tool implementation-specific information.

In the example of FIG. 3, the security engine 328 is configured to authenticate access to the non-disruptive continuous delivery system 302. For example, the security engine 328 can compare permissions of an associated project, application, continuous delivery pipeline, etc., with the permissions of a user before allowing the user to modify, execute, or otherwise access the associated project, application, continuous delivery pipeline, etc. In a specific implementation, the security engine 328 can also be configured to provide encryption, decryption, or other security measures for the non-disruptive continuous delivery system 302. For example, the security engine 328 can encrypt data messages transmitted from the system 302 and decrypt data messages received at the system 302.

In the example of FIG. 3, the communication engine 330 functions to send requests to and receive data from one or a plurality of systems. The communication engine 330 can send requests to and receive data from a system through a network or a portion of a network. Depending upon implementation-specific or other considerations, the communication engine 330 can send requests and receive data through a connection, all or a portion of which can be a wireless connection. The communication engine 330 can request and receive messages, and/or other communications from associated systems.

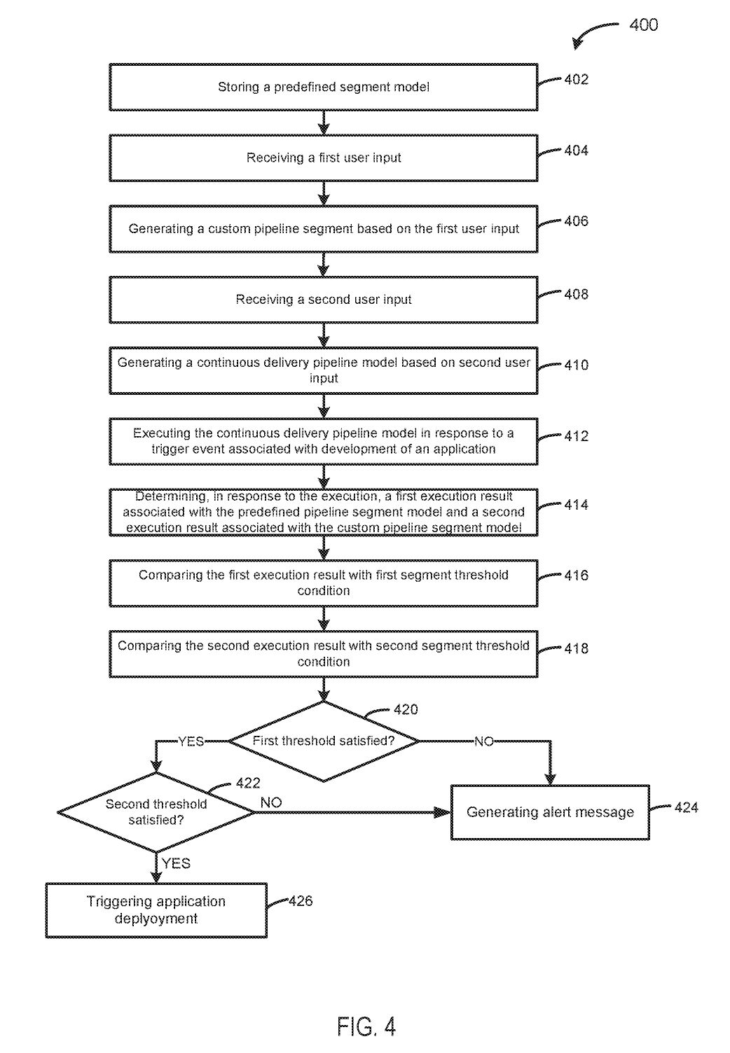

FIG. 4 depicts a flowchart 400 of an example method of generating and executing a custom segment model according to some embodiments.

In step 402, a non-disruptive continuous delivery system stores a predefined (or, “template”) segment model. For example, the template segment model can include a first segment model type, a first set of segment actions, a first sequence of the first set of segment actions, and a first segment threshold condition. In a specific implementation, the one or more template segment models are stored in a segment model datastore.

In step 404, the non-disruptive continuous delivery system receives a first user input. For example, the first user input can be received through a graphical user interface. In a specific implementation, a configurator engine receives the first user input.

In step 406, the non-disruptive continuous delivery system generates a custom segment model based on the user input. For example, the custom segment model can be based on a template segment model or created from scratch. In a specific implementation, a configurator engine generates the custom segment model.

In step 408, the non-disruptive continuous delivery system receives a second user input. For example, the second user input can be received through the graphical user interface. In a specific implementation, the configurator engine receives the second user input.

In step 410, the non-disruptive continuous delivery system generates a continuous delivery pipeline model based on the second user input, the continuous delivery pipeline model including at least the predefined segment model and the custom segment model. In a specific implementation, the configurator engine generates the continuous delivery pipeline model.

In step 412, the non-disruptive continuous delivery system executes the continuous delivery pipeline model in response to a trigger event associated with development of an application. In a specific implementation, an orchestrator engines executes the continuous delivery pipeline model.

In step 414, the non-disruptive continuous delivery system determines a first execution result associated with the predefined segment model, and a second execution result associated with the custom segment model. In a specific implementation, the orchestrator engine executes the continuous delivery pipeline model.

In step 416, the non-disruptive continuous delivery system compares the first execution result with the first segment threshold condition. In a specific implementation, the orchestrator engine performs the comparison.

In step 418, the non-disruptive continuous delivery system compares the second execution result with the second segment threshold condition. In a specific implementation, the orchestrator engine performs the comparison.

In step 420, the non-disruptive continuous delivery system determines whether the first segment threshold condition is satisfied. In a specific implementation, the orchestrator engine performs the determination. If the first segment threshold condition is not satisfied, the execution of the continuous delivery pipeline can be terminated and an alert can be generated (step 424). In a specific implementation, the orchestrator engine performs the termination and/or generates the alert.

If the first threshold condition is satisfied, the non-disruptive continuous delivery system can determine if the second threshold condition is satisfied (step 422). In a specific implementation, the orchestrator engine performs the determination. If the second segment threshold condition is not satisfied, the execution of the continuous delivery pipeline can be terminated and an alert can be generated (step 424). In a specific implementation, the orchestrator engine performs the termination and/or generates the alert.

In step 426, if the second threshold condition is satisfied, the non-disruptive continuous delivery system can trigger a deployment of the application. In a specific implementation, the orchestrator engine triggers the deployment of the application.

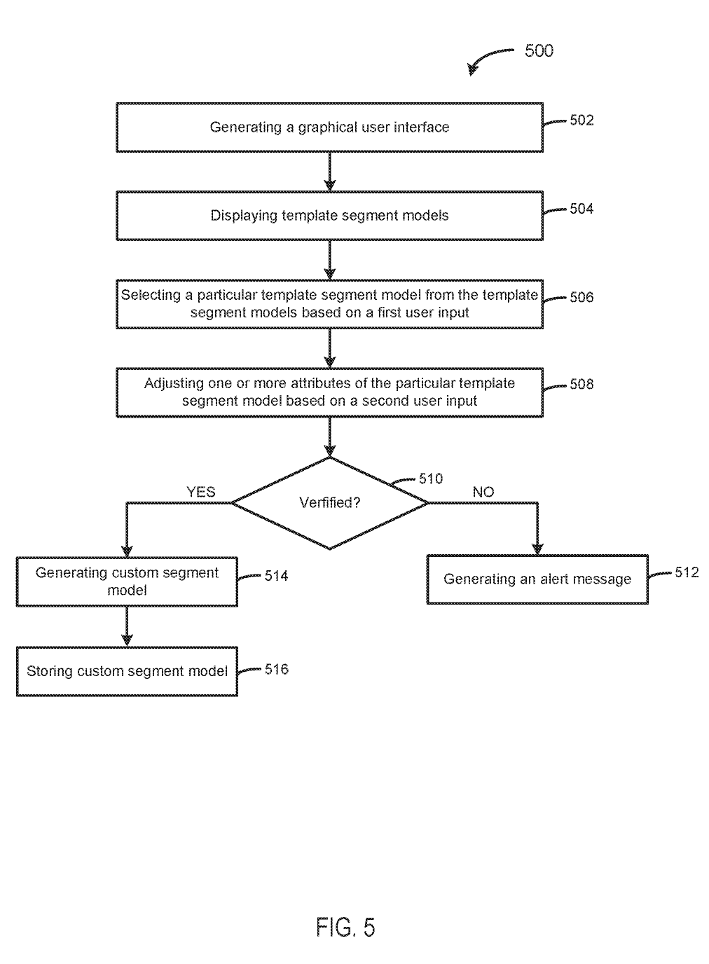

FIG. 5 depicts a flowchart 500 of an example method of generating a custom segment model from a template segment model according to some embodiments.

In step 502, a non-disruptive continuous delivery system generates a graphical user interface for creating a segment model. For example, the segment model can be created from a template segment model or a combination of template segment models. In a specific implementation, a configurator interface engine generates the graphical user interface.

In step 504, the non-disruptive continuous delivery system displays one or more template segment models. In a specific implementation, the configurator interface engine displays the one or more template segment models.

In step 506, the non-disruptive continuous delivery system selects a particular template segment model from the one or more template segment models based on a first user input. In a specific implementation, a configurator engine selects the particular template segment model, and the first user input is received through the graphical user interface.

In step 508, the non-disruptive continuous delivery system adjusts one or more attributes (e.g., segment type, segment actions, segment action definitions, segment action sequence, segment threshold conditions, etc.) of the particular template segment model based on a second user input. As used in this paper, an adjustment can include one or more create, update, and/or delete operations. In a specific implementation, the configurator engine performs the adjustment, and the second user input is received through the graphical user interface.

In step 510, the non-disruptive continuous delivery system verifies the adjustment based on one or more rules. For example, the non-disruptive continuous delivery system can determine whether some or all of the adjustments are within acceptable predetermined parameters, whether some or all of the adjustments violate any dependencies, and so forth. For example, an adjustment may not be verified if a sequence of actions is reordered such that a particular task would not have a required input, e.g., because that particular task was reordered to execute before the task that would generated that required input. If the adjustment is not verified, the non-disruptive continuous delivery system can generate an alert (step 512). For example, the alert can indicate verification denial, a cause for the verification denial, and/or prompt a user to modify the adjustment. In a specific implementation, this can be repeated, e.g., until the adjustment is verified.

In step 514, if the adjustment is verified, the non-disruptive continuous delivery system generates a custom segment model based on the adjustment. In a specific implementation, the configurator engine generates the custom segment model.

In step 516, the non-disruptive continuous delivery system stores the custom segment model. For example, the custom segment model can replace the particular template segment model or be stored in addition to the particular template segment model. In a specific implementation, the custom segment model is stored in a segment model datastore.

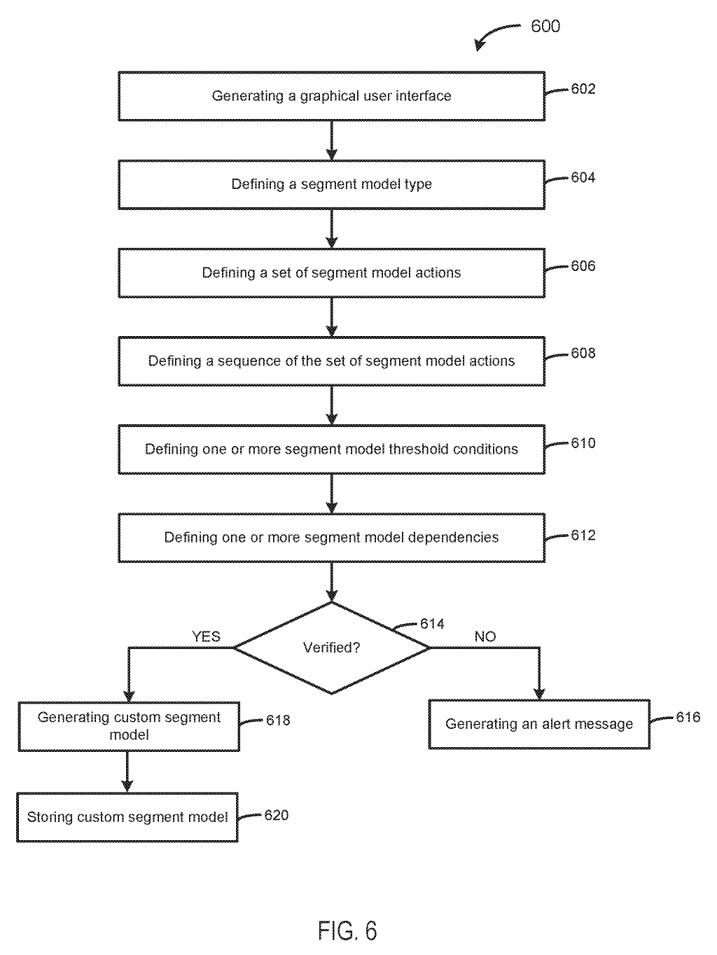

FIG. 6 depicts a flowchart 600 of an example method of generating a custom segment model according to some embodiments.

In step 602, a non-disruptive continuous delivery system generates a graphical user interface for creating a segment model. For example, the segment model can be created from a template segment model, combination of template segment models, and/or from scratch. In a specific implementation, a configurator interface engine generates the graphical user interface.

In step 604, the non-disruptive continuous delivery system defines a segment model type based on user input. For example, the segment model type can be a new segment model type, and/or defined based on a selection from a predetermined list of segment model types. In a specific implementation, a configurator engine defines the segment model type, and/or the user input is received through the graphical user interface.

In step 606, the non-disruptive continuous delivery system defines a set of segment model actions based on user input. In a specific implementation, the configurator engine defines the set of segment model actions based on user input, and/or the user input is received through the graphical user interface.

In step 608, the non-disruptive continuous delivery system defines a sequence of the set of segment model actions based on user input. In a specific implementation, the configurator engine defines the sequence of the set of segment model actions based on user input, and/or the user input is received through the graphical user interface.

In step 610, the non-disruptive continuous delivery system defines a set of segment model threshold conditions based on user input. In a specific implementation, the configurator engine defines the set of segment model threshold conditions based on user input, and/or the user input is received through the graphical user interface.

In step 612, the non-disruptive continuous delivery system defines a set of segment model dependencies based on user input. In a specific implementation, the configurator engine defines the set of segment model dependencies based on user input, and/or the user input is received through the graphical user interface.

In step 614, the non-disruptive continuous delivery system verifies the segment model definitions based on one or more rules. For example, the non-disruptive continuous delivery system can determine whether some or all of the segment model definitions are within acceptable predetermined parameters, whether some or all of the segment model definitions violate any dependencies, and so forth. For example, a segment model definition may not be verified if a sequence of actions is reordered such that a particular task would not have a required input, e.g., because that particular task was reordered to execute before the task that would generated that required input. If a segment model definition is not verified, the non-disruptive continuous delivery system can generate an alert (step 616). For example, the alert can indicate verification denial for the violated segment definition(s), a cause for the verification denial, and/or prompt a user to modify the segment definition(s). In a specific implementation, this can be repeated, e.g., until the segment definitions are verified.

In step 618, if the segment model definitions are verified, the non-disruptive continuous delivery system generates a custom segment model based on the segment model definitions. In a specific implementation, the configurator engine generates the custom segment model.

In step 620, the non-disruptive continuous delivery system stores the custom segment model. In a specific implementation, the custom segment model is stored in a segment model datastore.

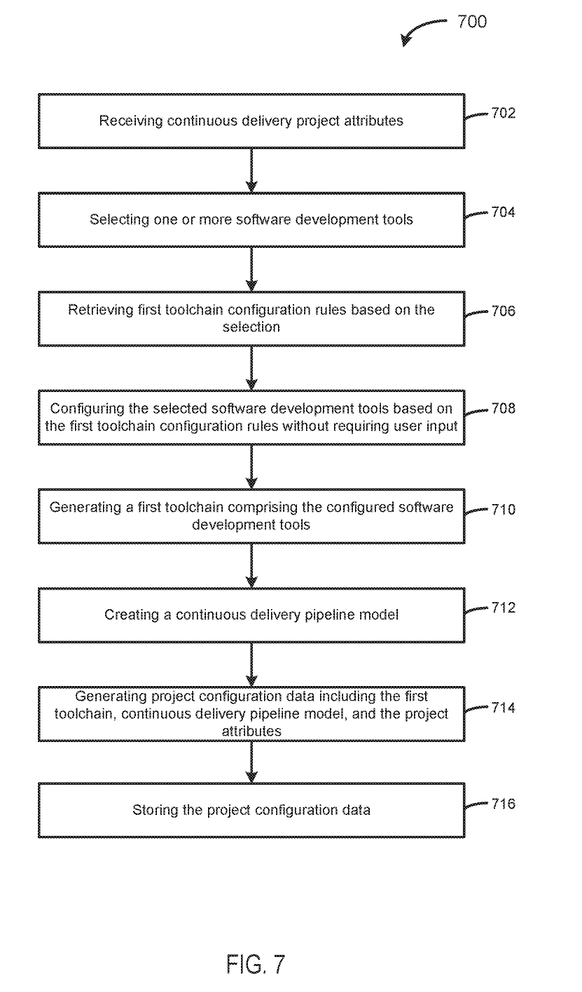

FIG. 7 depicts a flowchart 700 of an example method of operation of a non-disruptive continuous delivery system for generating and configuring a project and a project application according to some embodiments.

In step 702, a non-disruptive continuous delivery system receives continuous delivery project (or, “project”) attributes. For example, the attributes can be based on user input (e.g., a project name) received through a graphical user interface, and/or generated by the non-disruptive continuous delivery system (e.g., a project key) in response to user input. In a specific implementation, a configurator interface engine receives the project attributes.

In step 704, the non-disruptive continuous delivery system selects one or more software development tools (or, “tools”). For example, the tools can be selected based on user input (e.g., “Stash”) received through the graphical user interface, and/or automatically generated by the non-disruptive continuous delivery system (e.g., based on a default set of tool selections).

In step 706, the non-disruptive continuous delivery system retrieves one or more first toolchain configuration rules based on the tool selections. For example, the rules may comprise predefined implementation-specific tool configurations. In a specific implementation, a configurator engine retrieves the rules from a rules database.

In step 708, the non-disruptive continuous delivery system configures the selected tools based on the first toolchain configuration rules without requiring user input. In a specific implementation, the configurator engine performs such “automatic” tool configurations. In step 710, the non-disruptive continuous delivery system generates a first toolchain comprising the configured tools.

In step 712, the non-disruptive continuous delivery system creates a continuous delivery pipeline model. In a specific implementation, the configurator engine creates the continuous delivery pipeline model based on, and in response to, user input received by the configurator interface engine through the graphical user interface.

In step 714, the non-disruptive continuous delivery system generates project configuration data comprising the project attributes, first toolchain, and the continuous delivery pipeline model. In step 716, the non-disruptive continuous delivery system stores the project configuration data. In a specific implementation, the project configuration data is stored in one or more databases, e.g., a project database, a pipeline model database, and/or a pipeline segment model database.

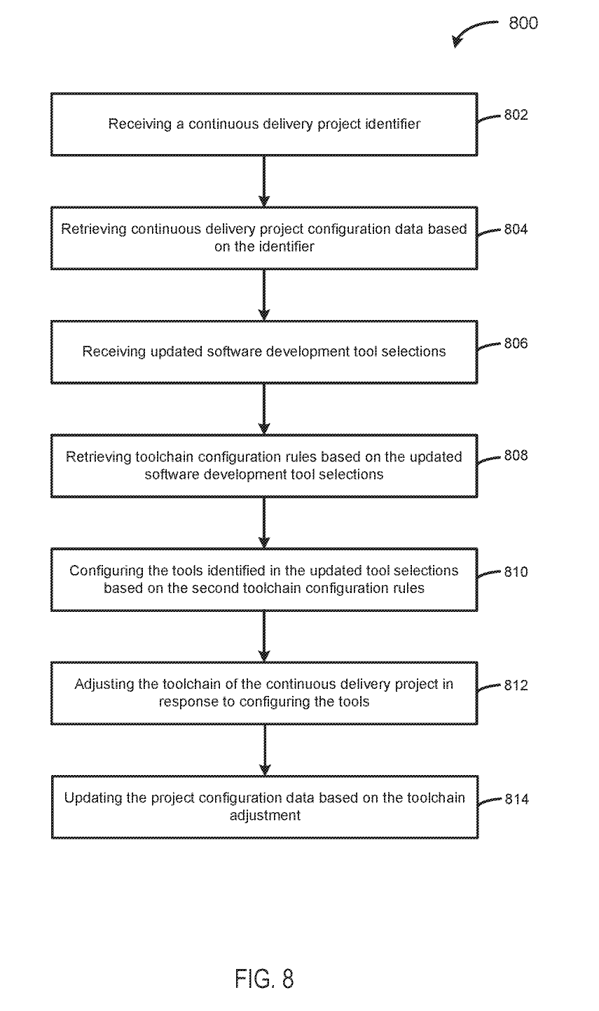

FIG. 8 depicts a flowchart 800 of an example method of operation of a non-disruptive continuous delivery system for adjusting a project and application configuration according to some embodiments.

In step 802, a non-disruptive continuous delivery system receives a continuous delivery project (or, “project”) identifier. For example, the identifier can be received in response to user input (e.g., a project name) received through a graphical user interface, and/or received in response to a request by a component (e.g., a configurator engine) of the non-disruptive continuous delivery system. In a specific implementation, a configurator interface engine receives the project attributes.

In step 804, the non-disruptive continuous delivery system retrieves project configuration data based on the identifier. In a specific implementation, the configurator engine retrieves the project configuration data from one or more databases, e.g., a project database, application database, and/or pipeline model database.

In step 806, the non-disruptive continuous delivery system receives updated software development tool (or, “tool”) selections. For example, the updated tool selections can be based on user input received through the graphical user interface, and/or generated by the non-disruptive continuous delivery system. In a specific implementation, the configurator interface engine receives the updated tool selections.

In step 808, the non-disruptive continuous delivery system retrieves one or more toolchain configuration rules based on the updated tool selections. For example, the one or more toolchain configuration rules may comprise predefined implementation-specific tool configurations. In a specific implementation, a configurator engine retrieves the one or more toolchain configuration rules from a rules database.

In step 810, the non-disruptive continuous delivery system configures the updated tools based on the toolchain configuration rules without requiring user input. In a specific implementation, the configurator engine performs such “automatic” tool configurations.

In step 812, the non-disruptive continuous delivery system adjusts the toolchain of the project in response to configuring the tools. In a specific implementation, the configurator engine performs the adjustment.

In step 814, the non-disruptive continuous delivery system updates the project configuration data based on the toolchain adjustment. In a specific implementation, the configurator engine performs the update.

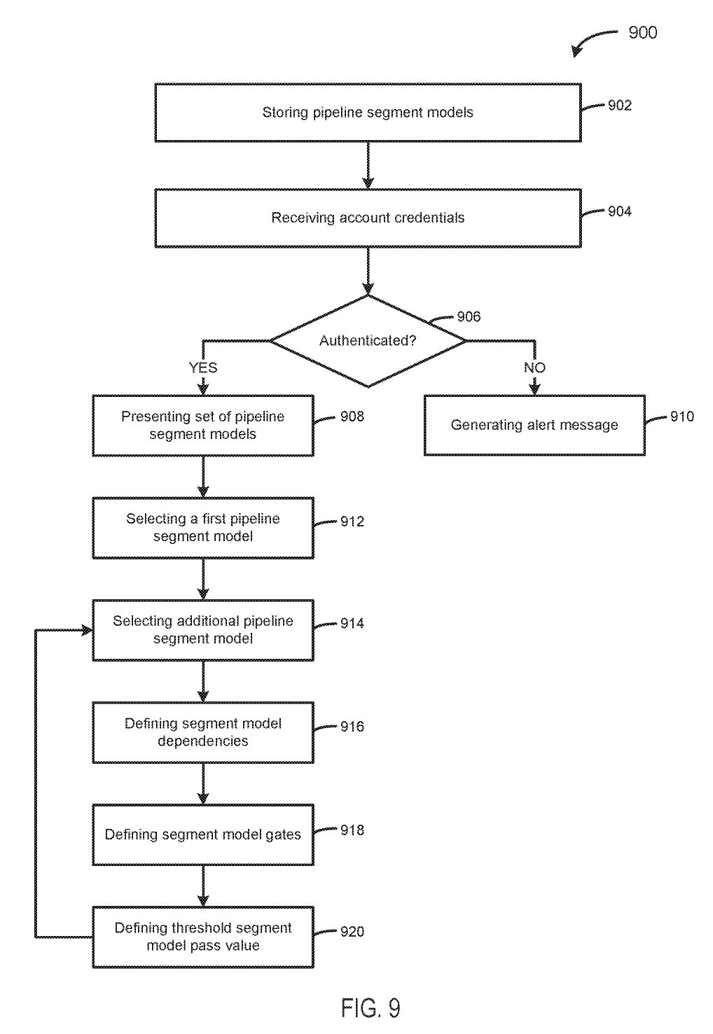

FIG. 9 depicts a flowchart 900 of an example method of operation of a non-disruptive continuous delivery system for creating a continuous delivery pipeline model according to some embodiments.

In step 902, a non-disruptive continuous delivery system stores a plurality of pipeline segment models. In a specific implementation, the plurality of pipeline segment models are stored in a pipeline segment model database.

In step 904, the non-disruptive continuous delivery system receives account credentials (e.g., a username and password). In a specific implementation, the account credentials are received through a graphical user interface generated by a configurator interface engine.

In step 906, the non-disruptive continuous delivery system attempts to authenticate the account credentials. If the authentication is successful, a set of pipeline segment models are presented (step 908). For example, the pipeline segment models can be presented through the graphical user interface by the configurator interface engine. Alternatively, if the authentication fails, the method may terminate and generate an alert message indicating a failed authentication (step 910). In a specific implementation, a security engine performs the authentication.

In step 912, the non-disruptive continuous delivery system selects a first pipeline segment model. In a specific implementation, the first pipeline segment model is selected from a set of available (or, “candidate”) pipeline segment models. For example, the first pipeline segment model can be selected based on, and in response to, user input received through the graphical user interface generated by the configurator interface engine.

In step 914, the non-disruptive continuous delivery system selects an additional pipeline segment model. In a specific implementation, the additional pipeline segment model is selected from the set of candidate pipeline segment models. For example, the additional pipeline segment model can be selected based on, and in response to, an additional user input received through the graphical user interface generated by the configurator interface engine.

In step 916, the non-disruptive continuous delivery system defines one or more segment model dependencies between the additional pipeline segment model and the first pipeline segment model. For example, a segment model dependency may define that the additional pipeline segment model can only execute if the first pipeline segment model is successfully completed. By way of further example, the segment model dependency may define that the additional pipeline segment model receives as input the output of the first pipeline segment model. In a specific implementation, a configurator engine defines the segment model dependency.

In step 918, the non-disruptive continuous delivery system defines one or more segment model gate conditions for the first pipeline segment model and/or the additional pipeline segment model. For example, the segment model gate conditions can include requiring administrator approval to advance to subsequent pipeline segment models. In a specific implementation, the configurator engine generates the gate conditions based on one or more rules. In a specific implementation, the configurator interface engine defines the gate conditions based on user input received through the graphical user interface.

In step 920, the non-disruptive continuous delivery system defines one or more segment model threshold conditions for the first pipeline segment model and the second pipeline segment model. For example, the segment model threshold conditions can be generated by the configurator engine based on one or more rules. In a specific implementation, the configurator interface engine defines one or more of the segment model threshold conditions based on user input received through the graphical user interface generated by the configurator interface engine. It will be appreciated that one or more of the steps 914-920 can be repeated until the continuous delivery pipeline model is completed.

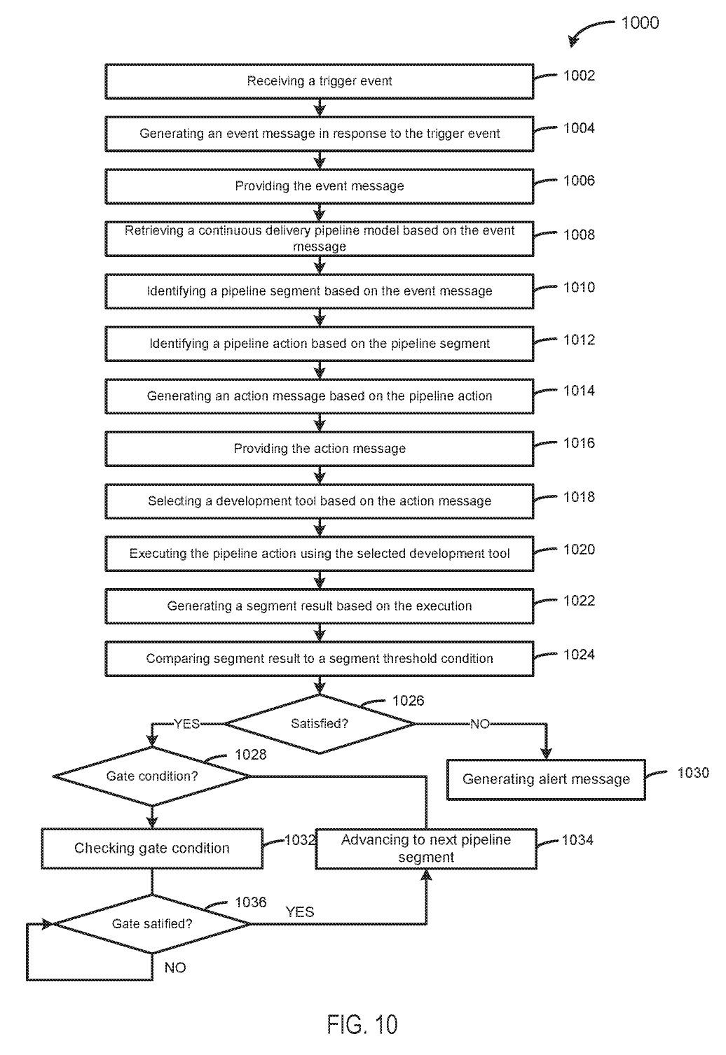

FIG. 10 depicts a flowchart 1000 of an example method of operation of a non-disruptive continuous delivery system for executing a continuous delivery pipeline model according to some embodiments.

In step 1002, a non-disruptive continuous delivery system receives a trigger event (e.g., a source code commit event). For example, the trigger event can be received by a toolchain engine from a client system and/or software development tool (or, “tool”).

In step 1004, the non-disruptive continuous delivery system generates an event in response to the trigger event. In a specific implementation, the event is generated by a non-disruptive toolchain engine.

In step 1006, the non-disruptive continuous delivery system provides the event. In a specific implementation, the event is provided to an orchestrator engine.

In step 1008, the non-disruptive continuous delivery system retrieves a continuous delivery pipeline model based on the event. In a specific implementation, a configurator engine retrieves the continuous delivery pipeline model from a pipeline database.

In step 1010, the non-disruptive continuous delivery system identifies a pipeline segment model based on the event. In a specific implementation, the orchestrator engine identifies the pipeline segment model.

In step 1012, the non-disruptive continuous delivery system identifies an action based on the pipeline segment model. In a specific implementation, the orchestrator engine identifies the pipeline segment model.

In step 1014, the non-disruptive continuous delivery system generates an action message based on the action. In a specific implementation, the orchestrator engine generates the action message.

In step 1016, the non-disruptive continuous delivery system provides the action message. In a specific implementation, the orchestrator engine provides the action message to the non-disruptive toolchain engine.

In step 1018, the non-disruptive continuous delivery system selects one or more tools based on the action message. In a specific implementation, the toolchain engine selects the one or more tools.

In step 1020, the non-disruptive continuous delivery system triggers execution of the action using the selected one or more tools. In a specific implementation, the orchestrator engine triggers the non-disruptive toolchain engine to instruct the selected tools to perform the action.

In step 1022, the non-disruptive continuous delivery system generates a pipeline segment model execution result based on the execution. In a specific implementation, the orchestrator engine generates the segment model execution result.

In step 1024, the non-disruptive continuous delivery system compares the segment model execution result with a threshold condition. In a specific implementation, the orchestrator engine performs the comparison.

In step 1026, the non-disruptive continuous delivery system, if the condition is satisfied, determines if any gate conditions are defined for the pipeline segment model (step 1028). Alternatively, if the condition is not satisfied, the process is terminated and an alert message is generated indicating the threshold conditions was not satisfied (step 1030). In a specific implementation, the orchestrator engine performs the determination and generates the alert message.

In step 1032, if there is a defined gate condition for the pipeline segment model, the non-disruptive continuous delivery system checks the gate condition. In a specific implementation, the orchestrator engine checks the gate condition.

In step 1034, if a gate condition is not defined for the pipeline segment model, the non-disruptive continuous delivery system advances to the next pipeline segment model of the continuous delivery pipeline model. In a specific implementation, the orchestrator engine advances the execution of the continuous delivery pipeline model to the next pipeline segment model.

In step 1036, if the gate condition is satisfied, the non-disruptive continuous delivery system advances to the next pipeline segment model (step 1034). If the condition is not satisfied, step 1036 can be repeated until satisfied.

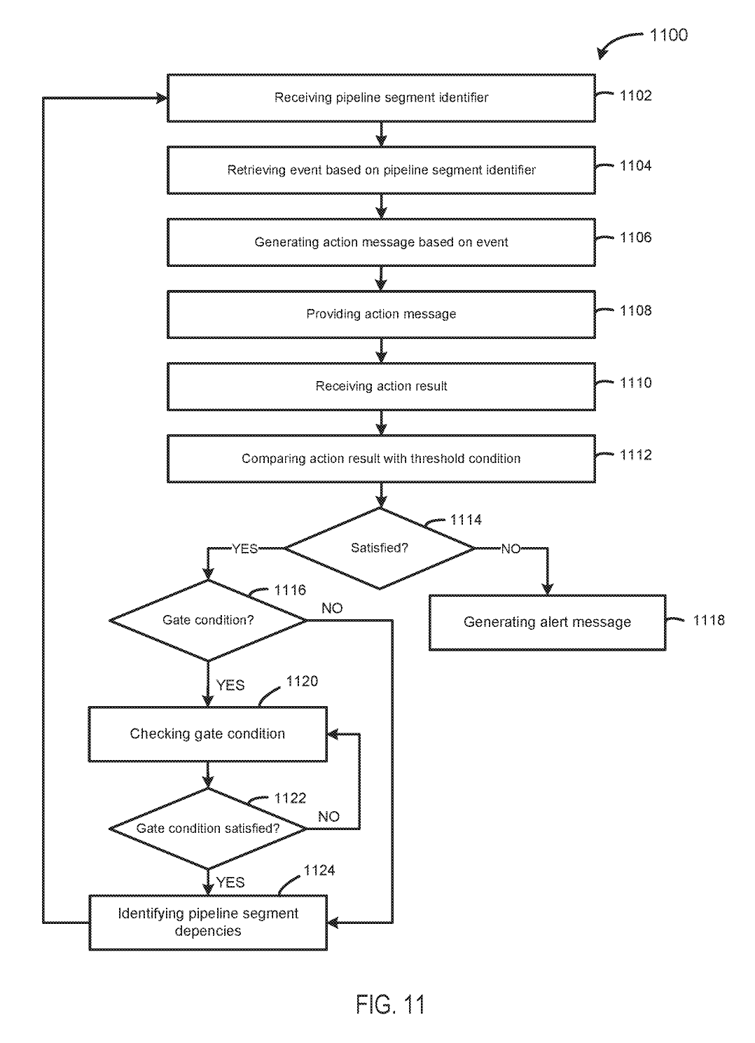

FIG. 11 depicts a flowchart 1100 of an example method of operation of a non-disruptive continuous delivery system for executing a pipeline segment model of a continuous delivery pipeline model according to some embodiments.

In step 1102, a non-disruptive continuous delivery system receives a pipeline segment model identifier. In step 1104, the non-disruptive continuous delivery system receives an event based on the pipeline segment model identifier. In step 1106, the non-disruptive continuous delivery system generates an action message based on the event. In step 1108, the non-disruptive continuous delivery system provides the action message. In step 1110, the non-disruptive continuous delivery system receives an action result. In step 1112, the non-disruptive continuous delivery system compares the action result with a threshold condition (e.g., a pipeline segment model threshold condition)

In step 1114, if the threshold condition is satisfied, the non-disruptive continuous delivery system determines if any gate conditions are defined for the pipeline segment model (step 1116). Alternatively, if the threshold condition is not satisfied, the process is terminated and alert message is generated indicating the threshold conditions was not satisfied (step 1118). In a specific implementation, the orchestrator engine performs the determination and generates the alert message.

In step 1120, if there is a defined gate condition, the non-disruptive continuous delivery system checks the gate condition (step 1122). In a specific implementation, the orchestrator engine checks the gate condition. If a gate condition is not defined, or if the gate condition defined and satisfied, the non-disruptive continuous delivery system identifies pipeline segment model dependencies (step 1124). In a specific implementation, the orchestrator engine identifies the pipeline segment model dependencies. Steps 1102-1124 can be repeated until the execution is completed, terminated, and/or held.

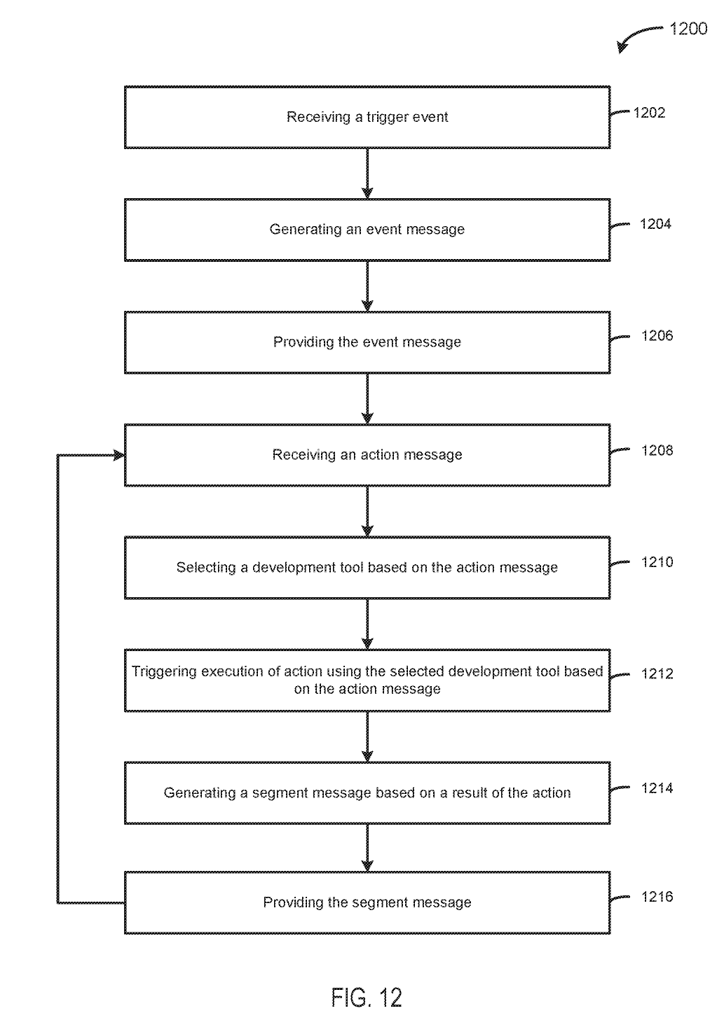

FIG. 12 depicts a flowchart 1200 of an example method of operation of a non-disruptive toolchain engine according to some embodiments.

In step 1202, a non-disruptive toolchain engine receives a trigger event. In step 1204, the non-disruptive toolchain engine generates an event message in response to the trigger event. In step 1206, the non-disruptive toolchain engine provides the event message (e.g., to an orchestrator engine). In step 1208, the non-disruptive toolchain engine receive an action message (e.g., from an orchestrator engine). In step 1210, the non-disruptive toolchain engine selects a tool based on the action message. In step 1212, the non-disruptive toolchain engine triggers execution of an action by the selected tool based on the action message. In step 1214, the non-disruptive toolchain engine generates a segment model message based on a result of the action execution. In step 1216, the segment model event message is provided (e.g., to the orchestrator engine). It will be appreciated that steps 1208-1216 can be repeated until pipeline execution has completed, terminated, and/or held.

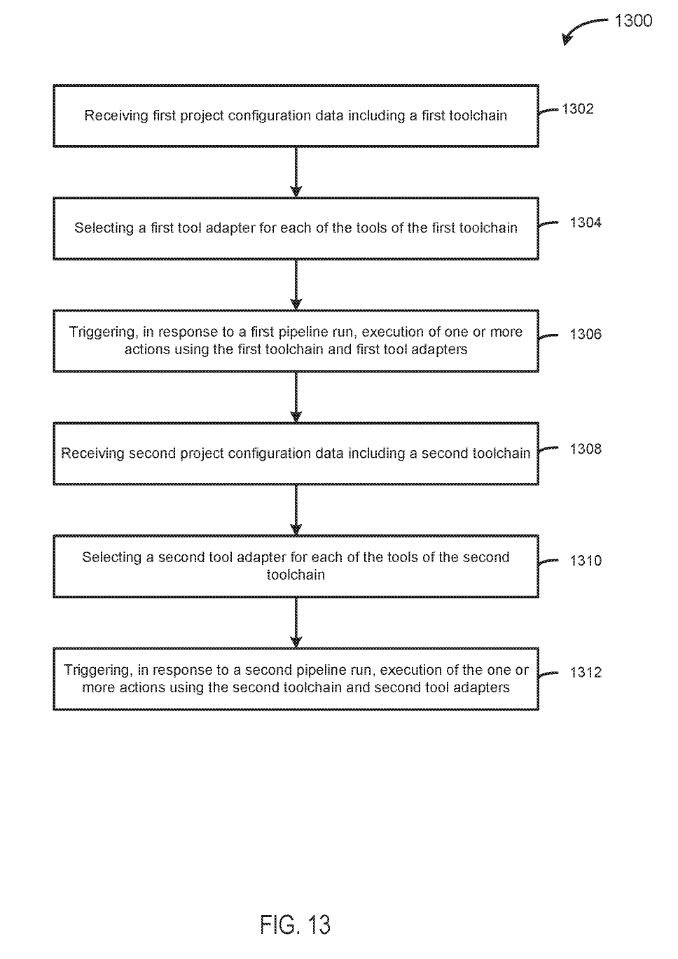

FIG. 13 depicts a flowchart 1300 of an example method of operation of a non-disruptive toolchain engine according to some embodiments.

In step 1302, a non-disruptive toolchain engine receives first project configuration data including a first toolchain. In step 1304, the non-disruptive toolchain engine selects a first tool adapter for each of the tools of the first toolchain. In step 1306, the non-disruptive toolchain engine, in response to a first execution (or, “run”) of a continuous delivery pipeline model, triggers the first toolchain to execute one or more actions using the first tool adapters. In step 1308, the non-disruptive toolchain engine receives second project configuration including a second toolchain. In step 1310, the non-disruptive toolchain engine selects a second tool adapter for each of the tools of the second toolchain. In step 1312, the non-disruptive toolchain engine, in response to a second run of the continuous delivery pipeline model, triggers the second toolchain to execute the one or more actions using the second tool adapters.

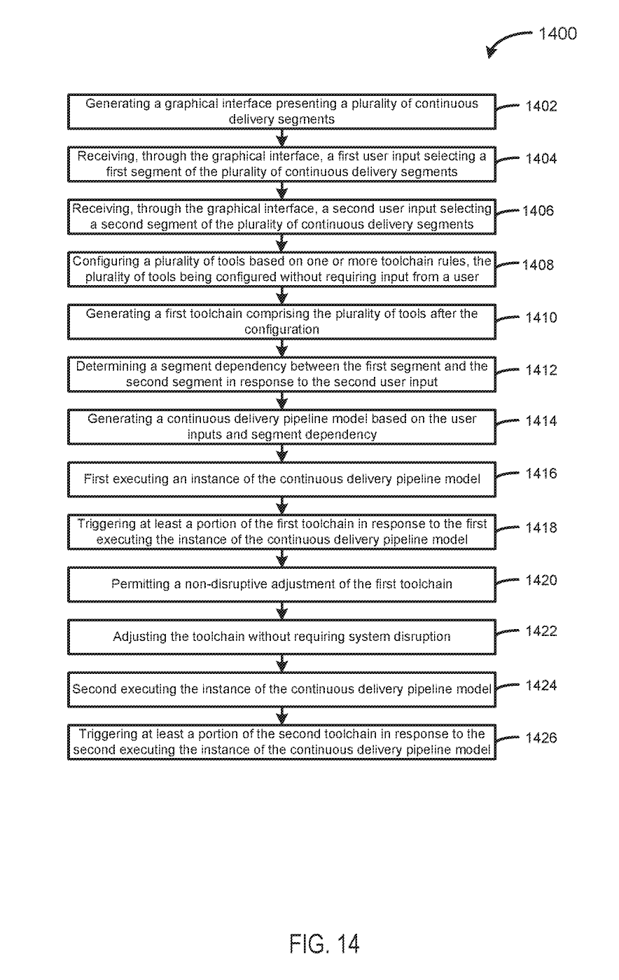

FIG. 14 depicts a flowchart 1400 of an example method of operation of a non-disruptive continuous delivery system according to some embodiments.

In step 1402, a non-disruptive continuous delivery system generates a graphical interface presenting a plurality of continuous delivery segment models. In a specific implementation, a configurator interface engine generates the graphical interface.

In step 1404, the non-disruptive continuous delivery system receives, through the graphical interface, a first user input selecting a first segment model of the plurality of continuous delivery segment models. In a specific implementation, the configurator interface engine receives the first user input.

In step 1406, the non-disruptive continuous delivery system receives, through the graphical interface, a second user input selecting a second segment model of the plurality of continuous delivery segment models. In a specific implementation, the configurator interface engine receives the second user input.

In step 1408, the non-disruptive continuous delivery system configures a plurality of tools based on one or more toolchain rules, the plurality of tools being configured without requiring input from a user. In a specific implementation, a configurator engine configures the tools.

In step 1410, the non-disruptive continuous delivery system generates a first toolchain comprising the plurality of tools after the configuration. In a specific implementation, the configurator engine generates the first toolchain.

In step 1412, the non-disruptive continuous delivery system determines a segment model dependency between the first segment model and the second segment model. In a specific implementation, the configurator engine determines the segment model dependency in response to the second user input.

In step 1414, the non-disruptive continuous delivery system generates a continuous delivery pipeline model based on the first user input, the second user input, and the segment model dependency, the continuous delivery pipeline model including at least the first segment model and the second segment model. In a specific implementation, the configurator engine generates the continuous delivery pipeline model.

In step 1416, the non-disruptive continuous delivery system executes an instance of the continuous delivery pipeline model. In a specific implementation, an orchestrator engine executes the instance of the continuous delivery pipeline model.

In step 1418, the non-disruptive continuous delivery system triggers at least a portion of the first toolchain to perform a continuous delivery action associated with the continuous delivery pipeline model in response to the executing the instance of the continuous delivery pipeline model. In a specific implementation, a non-disruptive toolchain engine performs the triggering.

In step 1420, the non-disruptive continuous delivery system permits a non-disruptive adjustment of the first toolchain. In a specific implementation, the non-disruptive toolchain engine permits the non-disruptive adjustment.

In step 1422, the non-disruptive continuous delivery system adjusts the toolchain without requiring system disruption, thereby generating a second toolchain. In a specific implementation, the configurator engine adjusts the toolchain.

In step 1424, the non-disruptive continuous delivery system second executes the instance of the continuous delivery pipeline model. In a specific implementation, the orchestrator engine second executes the instance of the continuous delivery pipeline model.

In step 1426, the non-disruptive continuous delivery system triggers at least a portion of the second toolchain in response to the second executing the instance of the continuous delivery pipeline model. In a specific implementation, the non-disruptive toolchain engine performs the triggering.

FIG. 15 depicts an example graphical user interface 1500 for generating an example continuous delivery pipeline model 1502 according to some embodiments. The graphical user interface 1500 includes a continuous delivery pipeline model 1502 that is currently being created, a first pipeline segment model 1504, a second pipeline segment model 1506, a segment model dependency 1508, and candidate pipeline segment models 1510-1520. For example, the first segment model 1504 and second segment model 1506 may have been selected from the candidate pipeline segment models 1510-1522 in response to user input received through the graphical user interface 1500. For example, the user input can include “dragging and dropping” pipeline segment models from the candidate pipeline segment models 1510-1522 to a palette portion 1524 of the interface 1500. The segment model dependency 1508 may have been similarly defined in response to user input received through the graphical user interface 1500. Alternatively, the segment model dependency 1508 may have been automatically defined, e.g., based on one or more pipeline configuration rules.

FIG. 16 depicts an example continuous delivery pipeline model 1600 according to some embodiments. The continuous delivery pipeline model 1600 includes pipeline segment models 1602-1616 and segment model dependencies 1618-1632. In a specific implementation, the continuous delivery pipeline model 1600 comprises a directed node graph model, and the pipeline segment models 1602-1616 comprise nodes (or, vertices) of the directed node graph model, and the segment model dependencies 1618-1632 comprise edges of the directed node graph model.

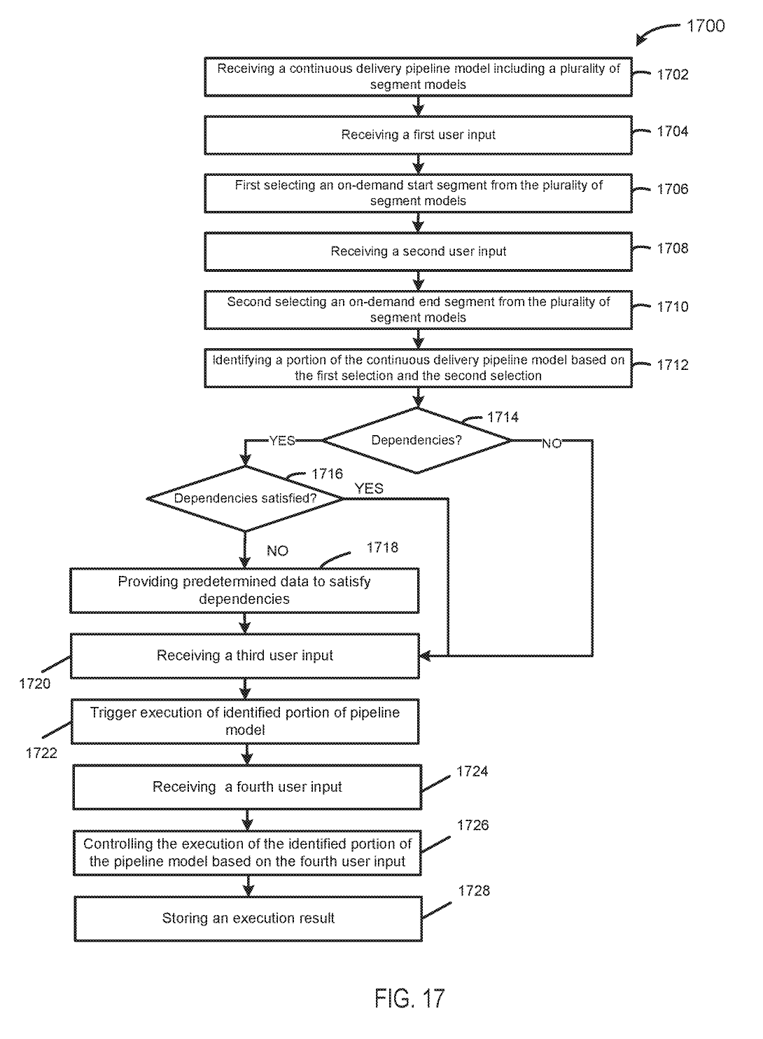

FIG. 17 depicts a flowchart 1700 of an example method of on-demand execution according to some embodiments.

In step 1702, a non-disruptive continuous delivery system receives a continuous delivery pipeline model including a plurality of segment models. In a specific implementation, an orchestrator engine receives the continuous delivery pipeline model.

In step 1704, the non-disruptive continuous delivery system receives a first user input. In a specific implementation, a configurator interface engine receives the first user input.

In step 1706, the non-disruptive continuous delivery system selecting an on-demand start segment from the plurality of segment models based on the first user input. In a specific implementation, the orchestrator engine performs the selection.

In step 1708, the non-disruptive continuous delivery system receives a second user input. In a specific implementation, the configurator interface engine receives the second user input.

In step 1710, the non-disruptive continuous delivery system selects an on-demand end segment from the plurality of segment models based on the second user input. In a specific implementation, the orchestrator engine performs the selection.

In step 1712, the non-disruptive continuous delivery system identifies a portion of the continuous delivery model based on the first selection and the second selection. In a specific implementation, an on-demand continuous delivery pipeline is generated from the identified portion. In a specific implementation, the orchestrator engine performs the identification and/or generation.

In step 1714, the non-disruptive continuous delivery system determines whether any dependencies exist for the identified portion of the continuous delivery pipeline model. For example, a dependency can include the on-demand start segment requiring a predetermined input value (e.g., a “pass” value) from another one of the plurality of segment models. In a specific implementation, the orchestrator engine performs the determination.

In step 1716, if there are any dependencies, the non-disruptive continuous delivery system generates and/or provides predetermined data (e.g., a pass value, sample code, etc.) sufficient to satisfy the dependency (step 1718). For example, the predetermined data can include segment model attribute values, pipeline model attribute values, source code associated with an application being developed in connection with the continuous delivery pipeline model, and the like. By way of further example, the source can include sample code generated based on a current code base of the application being developed, source code provided by a user, and so forth. It will be appreciated that this step may be performed automatically and/or in response to user input. For example, one or more rules may be executed to determine how to satisfy the dependencies without requiring user input. In a specific implementation, the orchestrator engine performs the functionality for this step.

In step 1720, the non-disruptive continuous delivery system receives a third user input. In a specific implementation, the configurator interface engine receives the third user input.

In step 1722, the non-disruptive continuous delivery system triggers execution of the identified portion of the continuous delivery model in response to the third user input. In a specific implementation, the orchestrator engine triggers the execution.

In step 1724, the non-disruptive continuous delivery system receives a fourth user input. In a specific implementation, the configurator interface engine receives the fourth user input.

In step 1726, the non-disruptive continuous delivery system controls the execution of the identified portion of the continuous delivery model in response to the fourth user input. For example, the execution can be aborted, paused, resume, skipped, and/or bypassed. In a specific implementation, the orchestrator engine performs the control.

In step 1728, the non-disruptive continuous delivery system stores a result of the execution and/or control of the identified portion of the continuous delivery model. In a specific implementation, the result is stored in a pipeline execution results datastore.

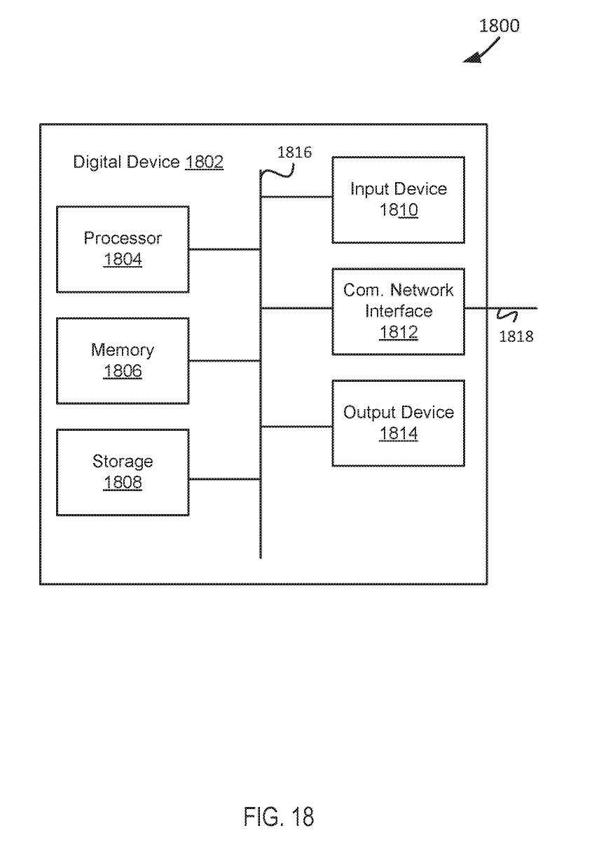

FIG. 18 depicts a block diagram 1800 of an example computing device 1802 according to some embodiments. Any of the client systems 102, non-disruptive continuous delivery system 104, development tools 106, production system 108, and communications network 110 may be an instance of one or more computing devices 1802. In the example of the FIG. 18, the computing device 1802 comprises a processor 1804, memory 1806, storage 1808, an input device 1810, a communications network interface 1812, and an output device 1814 communicatively coupled to a communication channel 1816. The processor 1804 is configured to execute executable instructions (e.g., programs). In some embodiments, the processor 1804 comprises circuitry or any processor capable of processing the executable instructions.

The memory 1806 stores data. Some examples of memory 1806 include storage devices, such as RAM, ROM, RAM cache, virtual memory, etc. In various embodiments, working data is stored within the memory 1806. The data within the memory 1806 may be cleared or ultimately transferred to the storage 1808.

The storage 1808 includes any storage configured to retrieve and store data. Some examples of the storage 1808 include flash drives, hard drives, optical drives, and/or magnetic tape. Each of the memory system 1806 and the storage system 1808 comprises a computer-readable medium, which stores instructions or programs executable by processor 1804.

The input device 1810 is any device that inputs data (e.g., mouse and keyboard). The output device 1814 outputs data (e.g., a speaker or display). For example, the output device 1814 can be one or more a cathode ray tube (CRT) device or liquid crystal display (LCD) devices. It will be appreciated that the storage 1808, input device 1810, and output device 1814 may be optional. For example, the routers/switchers may comprise the processor 1804 and memory 1806 as well as a device to receive and output data (e.g., the communications network interface 1812 and/or the output device 1814).

The communications network interface 1812 may be coupled to a network (e.g., network 108) via the link 1818. The communications network interface 1812 may support communication over an Ethernet connection, a serial connection, a parallel connection, and/or an ATA connection. The communications network interface 1812 may also support wireless communication (e.g., 1802.11a/b/g/n, WiMax, LTE, WiFi). It will be apparent that the communications network interface 1812 can support many wired and wireless standards.

It will be appreciated that the hardware elements of the computing device 1802 are not limited to those depicted in FIG. 18. A computing device 1802 may comprise more or less hardware, software and/or firmware components than those depicted (e.g., drivers, operating systems, touch screens, etc.). Further, hardware elements may share functionality and still be within various embodiments described herein. In one example, encoding and/or decoding may be performed by the processor 1804 and/or a co-processor located on a GPU (i.e., NVidia).

It will be appreciated that an “engine,” “device,” “tool,” “system,” and/or “database” may comprise software, hardware, firmware, and/or circuitry. In one example, one or more software programs comprising instructions capable of being executable by a processor may perform one or more of the functions of the engines, devices, tools, systems, and/or databases described herein. In another example, circuitry may perform the same or similar functions. Alternative embodiments may comprise more, less, or functionally equivalent engines, devices, tools, systems, and/or databases, and still be within the scope of present embodiments. For example, as previously discussed, the functions of the various engines, devices, tools, systems, and/or databases may be combined or divided differently.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, databases are intended to include repositories having any applicable organization of data, including tables, comma-separated values (CSV) files, traditional databases (e.g., SQL), or other applicable known or convenient organizational formats. Databases can be implemented, for example, as software embodied in a physical computer-readable medium on a specific-purpose machine, in firmware, in hardware, in a combination thereof, or in an applicable known or convenient device or system. Database-associated components, such as database interfaces, can be considered “part of” a database, part of some other system component, or a combination thereof, though the physical location and other characteristics of database-associated components is not critical for an understanding of the techniques described in this paper.

Databases can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The databases, described in this paper, can be cloud-based databases. A cloud based database is a database that is compatible with cloud-based computing systems and engines.

The present invention(s) are described above with reference to example embodiments. It will be apparent to those skilled in the art that various modifications may be made and other embodiments can be used without departing from the broader scope of the present invention(s). Therefore, these and other variations upon the example embodiments are intended to be covered by the present invention(s).

1. A method, comprising:
receiving, by a non-disruptive continuous delivery system, a continuous delivery pipeline model, the continuous delivery pipeline model comprising a plurality of segment models;
receiving, by the non-disruptive continuous delivery system, a first user input;
first selecting, by the non-disruptive continuous delivery system, an on-demand start segment from the plurality of segment models, the first selection based on the first user input;
receiving, by the non-disruptive continuous delivery system, a second user input;
second selecting, by the non-disruptive continuous delivery system, an on-demand end segment from the plurality of segments, the second selection based on the second user input;
identifying, by the non-disruptive continuous delivery system, a portion of the continuous delivery pipeline, the identification based on the first selection and the second selection;
receiving, by the non-disruptive continuous delivery system, a third user input; and
triggering, by the non-disruptive continuous delivery system, an on-demand execution of the identified portion of the continuous delivery pipeline model in response to the third user input.

2. The method of claim 1, further comprising determining a segment dependency based on the selection of the on-demand start segment and the on-demand end segment.

3. The method of claim 2, wherein the segment dependency comprises any of the on-demand start segment and the on-demand end segment requiring an input from at least one of the plurality of segment models not within the identified portion of the continuous delivery pipeline model.

4. The method of claim 2, further comprising reselecting any of the on-demand start segment and on-demand end segment to satisfy the segment dependency.

5. The method of claim 2, further comprising providing a sample input to satisfy the segment dependency.

6. The method of claim 1, further comprising receiving a fourth user input during the on-demand execution of the continuous delivery pipeline model.

7. The method of claim 1, further comprising terminating the execution of the continuous delivery model in response to fourth user input.

8. The method of claim 6, further comprising bypassing one or more segment models of the plurality of segment models during the execution of the continuous delivery model, the bypassing triggered in response to the fourth user input.

9. The method of claim 8, wherein the one or more segment models are logically positioned between the on-demand start segment and the on-demand end segment within the continuous delivery pipeline model.

10. A system, comprising:
a processor;
an orchestrator engine configured to cooperate with the processor to:
(i) receive a continuous delivery pipeline model, the continuous delivery pipeline model comprising a plurality of segment models,
(ii) first select an on-demand start segment from the plurality of segment models, the first selection based on a first user input,
(iii) second select an on-demand end segment from the plurality of segments, the second selection based on a second user input,
(iv) identify a portion of the continuous delivery pipeline, the identification based on the first selection and the second selection,
(v) trigger an on-demand execution of the identified portion of the continuous delivery pipeline model in response to a third user input.

11. The system of claim 10, wherein the orchestrator engine is further configured to determine a segment dependency based on the selection of the on-demand start segment and the on-demand end segment.

12. The system of claim 11, wherein the segment dependency comprises any of the on-demand start segment and the on-demand end segment requiring an input from at least one of the plurality of segment models not within the identified portion of the continuous delivery pipeline model.

13. The system of claim 11, wherein the orchestrator engine is further configured to reselect any of the on-demand start segment and on-demand end segment to satisfy the segment dependency.

14. The system of claim 11, wherein the orchestrator engine is further configured to provide a sample input to satisfy the segment dependency.

15. The system of claim 10, wherein the orchestrator engine is further configured to receive a fourth user input during the on-demand execution of the continuous delivery pipeline model.

16. The system of claim 10, wherein the orchestrator engine is further configured to terminate the execution of the continuous delivery model in response to fourth user input.

17. The system of claim 16, wherein the orchestrator engine is further configured to bypass one or more segment models of the plurality of segment models during the execution of the continuous delivery model, the bypassing triggered in response to the fourth user input.

18. The system of claim 17, wherein the one or more segment models are logically positioned between the on-demand start segment and the on-demand end segment within the continuous delivery pipeline model.

19. A non-transitory computer readable medium comprising executable instructions, the instructions being executable by a processor to perform a method, the method comprising:
receiving a continuous delivery pipeline model, the continuous delivery pipeline model comprising a plurality of segment models;
receiving a first user input;
first selecting an on-demand start segment from the plurality of segment models, the first selection based on the first user input;
receiving a second user input;
identifying a portion of the continuous delivery pipeline, the identification based on the first selection and the second selection;
second selecting an on-demand end segment from the plurality of segments, the second selection based on the second user input;
receiving a third user input; and
triggering an on-demand execution of the identified portion of the continuous delivery pipeline model in response to the third user input.

20. A system, comprising:
a means for receiving a continuous delivery pipeline model, the continuous delivery pipeline model comprising a plurality of segment models;
a means for receiving a first user input;
a means for first selecting an on-demand start segment from the plurality of segment models, the first selection based on the first user input;
a means for receiving a second user input;
a means for second selecting an on-demand end segment from the plurality of segments, the second selection based on the second user input;
a means for identifying a portion of the continuous delivery pipeline, the identification based on the first selection and the second selection;
a means for receiving a third user input; and
a means for triggering an on-demand execution of the identified portion of the continuous delivery pipeline model in response to the third user input.
